(19) United States
(12) Patent Application Publication
(10) Pub. No.: US 2014/0140731 A1
(43) Pub. Date: May 22, 2014

(54) TONER, DEVELOPER, IMAGE FORMING APPARATUS AND IMAGE FORMING METHOD

(71) Applicants: Mamoru Hozumi, Kanagawa (JP); Junichi Awamura, Shizuoka (JP); Teruki Kusahara, Shizuoka (JP); Daisuke Ito, Kanagawa (JP); Satoshi Ogawa, Nara (JP); Takahiro Honda, Shizuoka (JP); Kiwako Hirohara, Kanagawa (JP); Osamu Uchinokura, Shizuoka (JP); Satoshi Kojima, Shizuoka (JP); Syouko Satoh, Kanagawa (JP); Tsuneyasu Nagatomo, Shizuoka (JP); Masaki Watanabe, Shizuoka (JP); Masaaki Oka, Kyoto (JP); Yasuaki Ohta, Kyoto (JP)

(72) Inventors: Mamoru Hozumi, Kanagawa (JP); Junichi Awamura, Shizuoka (JP); Teruki Kusahara, Shizuoka (JP); Daisuke Ito, Kanagawa (JP); Satoshi Ogawa, Nara (JP); Takahiro Honda, Shizuoka (JP); Kiwako Hirohara, Kanagawa (JP); Osamu Uchinokura, Shizuoka (JP); Satoshi Kojima, Shizuoka (JP); Syouko Satoh, Kanagawa (JP); Tsuneyasu Nagatomo, Shizuoka (JP); Masaki Watanabe, Shizuoka (JP); Masaaki Oka, Kyoto (JP); Yasuaki Ohta, Kyoto (JP)

(21) Appl. No.: 14/130,812

(22) PCT Filed: Jul. 3, 2012
(86) PCT No.: PCT/JP2012/067414

§ 371 Date: Jan. 28, 2014

(30) Foreign Application Priority Data
Jul. 4, 2011 (JP) 2011-148332

(51) Int. Cl. G03G 9/087

(52) U.S. Cl. CPC G03G 9/08755
USPC 399/252; 430/108.4

(57) ABSTRACT

A toner including: a binder resin; a releasing agent; and a colorant, wherein the binder resin contains a crystalline polyester resin and a non-crystalline polyester resin, wherein the releasing agent has an endothermic peak temperature of 60° C. to 80° C. at the second temperature rising in differential scanning calorimetry, and wherein the releasing agent is an ester wax which satisfies the following expressions (1) and (2): 1.1 Pa·s≦η*a≦2.0 Pa·s . . . Expression (1) 0.001≦η*b/η*a≦1.00 . . . Expression (2) where in Expressions (1) and (2), η*a denotes a complex viscosity (Pa·s) determined by measuring a dynamic viscoelasticity of the releasing agent at a measurement frequency of 6.28 rad/s, and η*b denotes a complex viscosity (Pa·s) determined by measuring a dynamic viscoelasticity of the releasing agent at a measurement frequency of 62.8 rad/s.

### TECHNICAL FIELD

The present invention relates to a toner suitably used in, for example, electrophotography, electrostatic recording and electrostatic printing; and a developer, an image forming apparatus and an image forming method each using the toner.

### BACKGROUND ART

Copiers that have recently been demanded can consistently form high-quality images and are compact and able to copy a larger number of sheets at high speed. However, the current high-speed copiers have not necessarily achieved satisfactory high-speed processing. One possible reason for this is that optical equipment inside copiers is contaminated due to evaporation of wax and dust particles are released to the outside. In particular, the release of dust particles to the outside has recently been regulated from the viewpoint of environmental protection, since such dust particles cause a serious problem of adversely affecting human bodies. That is, it is possible for copiers to achieve a high-speed process by reducing the amount of volatile components contained in the wax.

For example, PTL 1 proposes a latent electrostatic image developing toner containing at least a binder resin, a colorant and an ester wax, wherein the ester wax is contained in the toner in an amount of 3 parts by mass to 40 parts by mass per 100 parts by mass of the binder resin, wherein the ester wax contains an ester compound represented by the following formula R₁—COO—R₂ [where R₁ and R₂ each represent a linear alkyl group having 15 to 45 carbon atoms] and wherein the ester wax contains ester compounds having the same total number of carbon atoms in an amount of 50% by mass to 95% by mass. The proposed latent electrostatic image developing toner can exhibit good low-temperature fixing property. However, this proposal did not consider any attempts to reduce the amount of volatile components in order to achieve the high-speed processing of copiers.

PTL 2 proposes a toner containing a polyalkylene as a releasing agent and describes that the toner has a fixing property resistant to factors derived from usage environments. However, this proposal did not consider use of an ester wax or use of an ester wax in a system containing a crystalline polyester resin.

Thus, at present, there have not yet been provided satisfactory toners or relevant techniques which exhibit good fixing property at 150° C. or lower to form good fixed images and which, even when in high-speed copiers, can highly suppress the contamination inside the copiers due to volatile wax dust particles and the release of the dust particles to the outside.

### CITATION LIST

### Patent Literature

PTL 1 Japanese Patent (JP-B) No. 3287733
PTL 2 Japanese Patent Application Laid-Open (JP-A) No. 2005-173315

### SUMMARY OF INVENTION

### Technical Problem

An object of the present invention is to provide: a toner which exhibits good fixing property at 150° C. or lower to form good fixed images and which, even when used in high-speed copiers, can highly suppress the contamination inside the copiers due to volatile wax dust particles and the release of the dust particles to the outside; and a developer, an image forming method and an image forming apparatus each using the toner.

### Solution to Problem

Means for solving the above problems are as follows.

A toner of the present invention includes:

a binder resin;

a releasing agent; and

a colorant,

wherein the binder resin contains a crystalline polyester resin and a non-crystalline polyester resin,

wherein the releasing agent has an endothermic peak temperature of 60° C. to 80° C. at the second temperature rising in differential scanning calorimetry, and

wherein the releasing agent is an ester wax which satisfies the following expressions (1) and (2):

1.1 Pa·s≦η*a≦2.0 Pa·s Expression (1)

0.001≦η*b/η*a≦1.00 Expression (2)

where in Expressions (1) and (2), η*a denotes a complex viscosity (Pa·s) determined by measuring a dynamic viscoelasticity of the releasing agent at a measurement frequency of 6.28 rad/s, and η*b denotes a complex viscosity (Pa·s) determined by measuring a dynamic viscoelasticity of the releasing agent at a measurement frequency of 62.8 rad/s.

### Advantageous Effects of Invention

The present invention can provide: a toner which exhibits good fixing property at 150° C. or lower to form good fixed images and which, even when used in high-speed copiers, can highly suppress the contamination inside the copiers due to volatile wax dust particles and the release of the dust particles to the outside; and a developer, an image forming method and an image forming apparatus each using the toner. These can solve the above problems and achieve the above objects.

### BRIEF DESCRIPTION OF DRAWINGS

FIG. 1 is a schematic view of one exemplary image forming apparatus of the present invention.

FIG. 2 is a schematic view of another exemplary image forming apparatus of the present invention.

FIG. 3 is an enlarged view of an image forming portion of the image forming apparatus of FIG. 2.

FIG. 4 is a schematic view of one exemplary process cartridge of the present invention.

### DESCRIPTION OF EMBODIMENTS

### Toner

A toner of the present invention contains a binder resin, a releasing agent and a colorant; and, if necessary, further contains other components.

The toner of the present invention contains a crystalline polyester resin as the binder resin. The crystalline polyester resin has high crystallinity and thus exhibits such a hot melt property that the viscosity is rapidly decreased in the vicinity of a temperature at which fixing is initiated. That is, use of the crystalline polyester resin provides a toner having both a good heat resistance storage stability and a good low-temperature fixing property, since the crystalline polyester resin exhibits a good heat resistance storage stability by keeping its crystallinity immediately before melting is initiated and is rapidly decreased in viscosity (sharp melt property) for fixing at a temperature at which melting is initiated. In addition, the toner containing the crystalline polyester resin has a suitable difference between the lower limit of the fixing temperature and the temperature at which hot onset occurs (i.e., a release range).

However, since part of the crystalline polyester resin present in the toner is in a compatible state with the non-crystalline polyester resin, the crystalline polyester resin tends to cause filming in a developing device, potentially leading to contamination of the developing device and degradation of images. Thus, it is necessary for the releasing agent to exude from the toner. In general, in polymeric releasing agents such as ester waxes, the kinetic state of their polymer chains changes with increasing of the temperature. The dynamic viscoelasticity resulting from the change in the kinetic state thereof depends on the frequency upon measurement of the dynamic viscoelasticity and on properties such as the molecular structure of the releasing agent. In addition, the dynamic viscoelasticity of the releasing agent is known to greatly change near the melting point thereof. The releasing agent is heated and melted in a short time upon fixing of the toner, and the fixing property depends on the change in dynamic viscoelasticity near the melting point thereof.

Therefore, the releasing agent used in the toner of the present invention is an ester wax which satisfies the following expressions (1) and (2):

1.1 Pa·s≦η*a≦2.0 Pa·s Expression (1)

0.001≦η*b/η*a≦1.00 Expression (2)

where in Expressions (1) and (2), η*a denotes a complex viscosity (Pa·s) determined by measuring a dynamic viscoelasticity of the releasing agent at a measurement frequency of 6.28 rad/s, and η*b denotes a complex viscosity (Pa·s) determined by measuring a dynamic viscoelasticity of the releasing agent at a measurement frequency of 62.8 rad/s.

In electrophotographic processes, the usage environments of the toner are varied with the image forming method used or the type of the image forming apparatus used. The vibration states of the toner in such usage environments can be replaced with the frequencies upon measurement of dynamic viscoelasticity. When considering the usage environments of the toner for evaluating its responses to frequencies, it is reasonable to employ two different measurement frequencies: 6.28 rad/s and 62.8 rad/s. Specifically, the ratio (η*b/η*a) between the complex viscosities at the different frequencies as shown in Expression (2) takes into consideration the dependency to the frequency in dynamic environments. The releasing agent that satisfies Expression (2) decreases in viscosity upon fixing (at high frequencies) similar to the crystalline polyester resin, not degrading the fixing property. Although middle- or high-speed image forming apparatus involve great change in environments therein through an image forming process including image formation and fixation, and an unstable, exuding releasing agent volatilizes to contaminate the interior of the apparatus and to be discharged to the outside as dust particles, the releasing agent that satisfies Expression (2) has high viscosity at low frequencies, being prevented from volatilization.

The complex viscosity η*a reflects the exuding property of the releasing agent melted in the toner, where greater η*a means that a less amount of the releasing agent exudes from the toner, and smaller η*a means that a greater amount of the releasing agent exudes from the toner.

The complex viscosity η*a determined by measuring the dynamic viscoelasticity at a measurement frequency of 6.28 rad/s is 1.1 Pa·s to 2.0 Pa·s as shown in Expression (1), preferably 1.2 Pa·s to 1.8 Pa·s.

When the complex viscosity η*a is less than 1.1 Pa·s, it is not possible for the releasing agent exuding from the toner upon heating for fixing to form a uniform coating layer on the image. In addition, when the image is heated and pressed with a fixing roller, the coating layer made of the releasing agent becomes ununiform (broken), potentially leading to unevenness in delamination. When the complex viscosity η*a is more than 2.0 Pa·s, the releasing agent is degraded in exuding property, potentially leading to degradation in releasing property.

Also, the ratio (η*b/η*a) between the complex viscosities at the different frequencies is 0.001 to 1.00 as shown in Expression (2), preferably 0.010 to 0.80.

When the ratio (η*b/η*a) of the complex viscosities is less than 0.001, although the releasing agent has a good property of exuding from the toner upon fixation, the molecular state of the releasing agent becomes unstable upon fixation or immediately after fixation and the releasing agent tends to volatilize, potentially leading to contamination of the interior of the apparatus and discharge of the releasing agent to the outside as powder. When the ratio (η*b/η*a) of the complex viscosities is higher than 1.00, the releasing agent is not sufficiently decreased in viscoelasticity upon fixation, leading to degradation of the low-temperature fixing property. In addition, the exuding property of the releasing agent from the toner is degraded, potentially leading to degradation of the releasing property.

Here, for measuring the dynamic viscoelasticity of the releasing agent, first, the releasing agent is extracted from the toner in the following manner.

Specifically, 30 g of a toner is added to 300 mL of ethyl acetate, followed by stirring at 35° C. for 30 min. The obtained solution is filtrated with a membrane filter having an aperture of 0.2 μm, to thereby remove resin components. Next, the obtained ethyl acetate-insoluble matter is treated with a Soxhlet extractor to extract hexane-soluble matter therefrom. Specifically, the ethyl acetate-insoluble matter is placed in a cylindrical filtration paper having an inner diameter of 24 mm which is then set to the extraction tube. The flask equipped with a condenser containing 300 mL of hexane is placed in a mantle heater to make the hexane be refluxed at 70° C. so that the hexane in the condenser is dropped to the ethyl acetate-insoluble matter and hexane-soluble matter is extracted into the flask. After the extraction for 10 hours, the hexane of the extract is evaporated under reduced pressure, whereby the wax dissolved can be extracted. In addition, the residue is dissolved in chloroform for preparing a sample for gel permeation chromatography (GPC), and the sample is injected to a GPC measuring apparatus (GPC-HLC-8120, product of TOSOH CORPORATION). A fraction collector is disposed on the eluate outlet port of the GPC to collect an eluate every predetermined count. The eluates corresponding to the peak of the GPC chromatograph are combined together, and the chloroform of the combined eluate is evaporated to obtain the eluted target product. In this manner, the releasing agent (wax) is extracted from the toner.

The dynamic viscoelasticity of the releasing agent extracted from the toner can be measured with, for example, the ARES measuring apparatus (product of Rheometric Scientific Co.). Notably, the dynamic viscoelasticity of the releasing agent itself can also be measured with the same apparatus.

First, the releasing agent sample is molded into a tablet. Then, parallel plates 50 mm in diameter are set to the top of the geometry and a cup 50 mm in diameter is set at the bottom thereof. After 0 point adjustment has been performed so that the normal force becomes 0, sine wave vibration is applied to the tablet at a vibration frequency of 6.28 rads to 62.8 rad/s.

The interval between the parallel plates is set to 1.0 mm, and measurement is preformed within −15° C. to +15° C. of the melting point of the releasing agent.

### <Releasing Agent>

The releasing agent used is an ester wax having the above-described dynamic viscoelasticity.

The ester wax is preferably a monoester synthesized from a monohydric alcohol and a linear fatty acid containing a long-chain alkyl group or a saturated ester synthesized from a linear fatty acid and a polyhydric alcohol. The ester wax is particularly preferably such a monoester wax from the viewpoint of obtaining good fixing property and good releasing property.

The ester wax may be appropriately synthesized or may be a commercially available one.

The ester wax is generally synthesized through esterification reaction between a long-chain fatty acid or polycarboxylic acid and a long-chain higher alcohol or polyhydric alcohol.

The long-chain fatty acid or polycarboxylic acid and the long-chain higher alcohol or polyhydric alcohol are often obtained from natural products, and are generally mixtures containing acids or alcohols each having an even number of carbon atoms.

The long-chain fatty acid is not particularly limited and may be appropriately selected depending on the intended purpose. Examples thereof include myristic acid, palmitic acid, stearic acid, arachidic acid, behenic acid and lignoceric acid. These may be used alone or in combination.

Examples of the polycarboxylic acid include benzenedicarboxylic acids (e.g., phthalic acid, isophthalic acid and terephthalic acid) or anhydrides thereof; alkyldicarboxylic acids (e.g., succinic acid, adipic acid, sebacic acid and azelaic acid) or anhydrides thereof unsaturated dibasic acids (e.g., maleic acid, citraconic acid, itaconic acid, alkenylsuccinic acid, fumaric acid and mesaconic acid); unsaturated dibasic acid anhydrides (e.g., maleic anhydride, citraconic anhydride, itaconic anhydride and alkenylsuccinic anhydride); trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-haxanetricarboxylic acid, 1,3-dicarboxyl-2-methyl-2-methylenecarboxypropane, tetrakis(methylenecarboxy)methane, 1,2,7,8-octanetetracarboxylic acid, Enpol trimer acid; anhydrides thereof; and partial alkyl esters thereof. These may be used alone or in combination.

The long-chain higher alcohol is not particularly limited and may be appropriately selected depending on the intended purpose. Examples thereof include capryl alcohol, capric alcohol, lauryl alcohol, myristyl alcohol, cetyl alcohol, steary alcohol, arachidyl alcohol, behenyl alcohol and lignoceryl alcohol. These may be used alone or in combination.

Examples of the polyhydric alcohol include ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, trimethylolpropane and 1,3,5-trihydroxybenzene. These may be used alone or in combination.

For example, the esterification reaction is performed at a reaction temperature of lower than 250° C. under normal or reduced pressure. Preferably, the esterification reaction is performed in an inert gas such as nitrogen gas. The ratio between the amount of the long-chain fatty acid or polycarboxylic acid and the amount of the long-chain higher alcohol or polyhydric alcohol is not particularly limited and may be appropriately selected depending on the intended purpose. A small amount of an esterification catalyst or a solvent may be used for the esterification reaction.

Examples of the esterification catalyst used include organic titanium compounds such as tetrabutoxy titanate and tetrapropioxy titanate; organic tin compounds such as butyl tin dilaurate and dibutyl tin oxide; organic lead compounds; and sulfuric acid. Examples of the solvent used include aromatic solvent such as toluene, xylene and mineral spirits.

When the long-chain fatty acid or polycarboxylic acid and the long-chain higher alcohol or polyhydric alcohol are directly subjected to esterification, byproducts having similar structures to the intended ester compound are formed, adversely affecting various properties of the toner. Thus, when the starting materials and the reaction products are purified through extraction with a solvent or distillation under reduced pressure, it is possible to obtain the ester wax suitably usable in the present invention.

The endothermic peak temperature of the releasing agent at the second temperature rising in differential scanning calorimetry is 60° C. to 80° C., preferably 70° C. to 80° C. When the endothermic peak temperature of the releasing agent at the second temperature rising is lower than 60° C., the releasing agent may adversely affect the heat resistance storage stability of the formed toner. Whereas when it is higher than 80° C., the formed toner is increased in fixing temperature and also tends to cause cold offset upon fixing at low temperatures. As a result, it may be difficult to properly smooth the surface of the fixed image, which may lead to degradation in color mixing property.

Here, the endothermic peak temperature of the ester wax can be measured at the second temperature rising in differential scanning calorimetry thereof.

Here, the endothermic peak temperature of the ester wax at the second temperature rising can be measured with a DSC system (differential scanning calorimeter) (“Q-200,” product of TA INSTRUMENTS Co.) in the following manner.

First, about 5.0 mg of the ester wax to be measured is precisely weighed and placed in a sample container made of aluminum; the sample container is placed on a holder unit; and the holder unit is set in an electric furnace. Next, in a nitrogen atmosphere (flow rate: 50 ml/min), the sample is heated from −20° C. to 150° C. under the following conditions: temperature increasing rate: 1° C./min; temperature modulation cycle: 60 sec; and temperature modulation amplitude: 0.159° C.; and then the sample is cooled from 150° C. to 0° C. at a temperature decreasing rate of 10° C./min. Thereafter, the sample is heated again to 150° C. at a temperature increasing rate of 1° C./min. The DSC curve obtained using the differential scanning calorimeter (“Q-200,” product of TA INSTRUMENTS Co.) is used to determine the endothermic peak temperature attributed to the ester wax at the second temperature rising.

The solubility of the releasing agent in ethyl acetate at 20° C. is preferably 7% by mass, more preferably 0% by mass to 7% by mass. When the solubility thereof is higher than 7% by mass, the releasing agent dissolved in ethyl acetate is attached on the toner surface during desolvation, potentially causing degradation in the heat resistance storage stability, contamination in the developing device, and image failures.

The melt viscosity of the ester wax is preferably 5 cps to 1,000 cps, more preferably 10 cps to 100 cps, as measured at a temperature higher by 20° C. than the melting point thereof. The wax having a melt viscosity of higher than 1,000 cps cannot satisfactorily improve hot offset resistance or low-temperature fixing property.

The ester wax preferably has a hardness of 0.5 to 5. When the hardness of the ester wax is less than 0.5, the fixing device greatly depends on the pressure and process speed, resulting in that the ester wax may be poor in the effect of preventing hot offset. Whereas when it is higher than 5, the storage stability of the toner decreases and the ester wax itself has poor self-aggregation property, resulting in that the ester wax may be poor in the effect of preventing hot offset.

The hardness of the ester wax is a Vickers hardness measured as follows. Specifically, the ester wax is formed into a cylindrical sample having a diameter of 20 mm and a thickness of 5 mm, and the Vickers hardness of the formed sample is measured using a dynamic ultra-micro hardness tester (DUH-200, product of Shimadzu Corporation).

More specifically, the sample is moved by a distance of 10 μm while a load of 0.5 g is being applied to the sample at a loading speed of 9.67 mm/sec, and then the sample is retained for 15 sec. The shape of the formed dent is measured to determine the Vickers hardness.

The amount of the ester wax contained in the toner is preferably 3 parts by mass to 40 parts by mass, more preferably 5 parts by mass to 35 parts by mass, per 100 parts by mass of the binder resin.

When the amount thereof is less than 3 parts by mass, the formed toner is degraded in hot offset resistance and also tends to cause an offset phenomenon when fixing the images on both front and back surfaces. When it is higher than 40 parts by mass, the toner particles formed by the pulverization method are easily fused in the production apparatus therefor, or the toner particles formed by the polymerization method are easily combined one another during granulation thereof, resulting in that the toner particles having a broad particle size distribution are easily formed and the durability of the toner may be decreased.

Even in a full-color image forming method including: forming a toner image on a latent electrostatic image bearing member with a toner containing the ester wax in an amount of 3 parts by mass to 40 parts by mass per 100 parts by mass of the binder resin; transferring the toner image from the latent electrostatic image bearing member to an intermediate transfer member; contacting a voltage-applied transfer roller to the intermediate transfer member to electrostatically transferring the toner image from the intermediate transfer member to a recording medium; and heating and fixing the toner image on the recording medium with a heating-pressing device, there is suppressed the toner fusion or filming on the latent electrostatic image bearing member or the intermediate transfer member.

A double-side fixing method is a method where a fixed image is previously formed on one surface of recording paper and then an image is formed on the other surface thereof. In this method, the previously fixed image is made to pass through the fixing device again, and thus it is necessary to sufficiently consider the hot offset resistance of the toner. Therefore, in the present invention, it is preferable to add a relatively large amount of the ester wax.

### <Binder Resin>

The binder resin contains a crystalline polyester resin and a non-crystalline polyester resin.

It is preferable that a modified polyester resin, a polyester resin that has not been modified (i.e., an unmodified polyester resin) and other binder resins are contained as the non-crystalline polyester resin.

### —Crystalline Polyester Resin—

The crystalline polyester resin is not particularly limited and may be appropriately selected depending on the intended purpose. The crystalline polyester resin is preferably those synthesized using alcohol components containing C2-20 diol compounds or derivatives thereof and acid components containing polycarboxylic acid compounds (e.g., aliphatic dicarboxylic acids, aromatic dicarboxylic acids and alicyclic dicarboxylic acids) or derivatives thereof. Among them, particularly preferred are crystalline polyester resins synthesized using saturated aliphatic dicarboxylic acids and saturated aliphatic diols.

In the present invention, the crystalline polyester resin refers to those obtained using polyhydric alcohol components and polycarboxylic acid components such as polycarboxylic acids, polycarboxylic anhydrides and polycarboxylic acid esters. Polyester resins that have been modified; e.g., the below-described binder resin precursor (prepolymer) and modified polyester resins obtained by crosslinking and/or elongating the prepolymer (i.e., modified polyester resins having at least one of a urethane bond and a urea bond) are not encompassed by the crystalline polyester resin in the present invention, but are treated as a binder resin precursor or a modified polyester resin.

The polyhydric alcohol component is not particularly limited and may be appropriately selected depending on the intended purpose. Examples thereof include C2-12 aliphatic diol compounds. Examples of the C2-12 aliphatic diol compounds include ethylene glycol, 1,2-propylene glycol, 1,3-propylene glycol, 1,4-butanediol, 1,5-pentanediol, 1,6-hexanediol, 1,7-heptanediol, 1,8-octanediol, 1,10-decanediol, 1,12-dodecanediol, neopentyl glycol and 1,4-butenediol. These may De used alone or in combination.

The polycarboxylic acid component is not particularly limited and may be appropriately selected depending on the intended purpose. Examples thereof include: aromatic carboxylic acids (e.g., phthalic acid, isophthalic acid and terephthalic acid) or derivatives thereof; and C2-12 saturated dicarboxylic acids (e.g., 1,4-butanedioic acid, 1,6-hexanedioic acid such as adipic acid, 1,8-octanedioic acid, 1,10-decanedioic acid and 1,12-dodecanedioic acid) or derivatives thereof. These may be used alone or in combination.

Among them, the crystalline polyester resin is particularly preferably formed between a C4-12 saturated aliphatic diol component which is 1,4-butanediol, 1,6-hexanediol, 1,8-octanediol or 1,10-decanediol, 1,12-dodecanediol and a C4-12 saturated aliphatic dicarboxylic acid component which is 1,4-butanedioic acid, 1,6-hexanedioic acid, 1,8-octanedioic acid, 1,10-decanedioic acid or 1,12-dodecanedioic acid. This is because the obtained crystalline polyester resin has high crystallinity and sharply changes in viscosity around the melting point thereof.

The melting point of the crystalline polyester resin is not particularly limited and may be appropriately selected depending on the intended purpose. It is preferably 55° C. to 80° C. When the melting point thereof is lower than 55° C., there may be degradation in heat resistance storage stability. Whereas when it is higher than 80° C., there may be degradation in low-temperature fixing property.

The melting point of the crystalline polyester resin refers to a temperature at which the crystalline polyester resin shows the maximum endothermic peak in a DSC curve thereof measured with a differential scanning calorimeter.

The amount of the crystalline polyester resin contained in the toner is not particularly limited and may be appropriately selected depending on the intended purpose. It is preferably 1% by mass to 10% by mass. When the amount thereof is less than 1% by mass, there may be degradation in low-temperature fixing property. Whereas when it is more than 10% by mass, there may be degradation in heat resistance storage stability.

### —Non-Crystalline Polyester Resin—

The non-crystalline polyester resin is obtained using polyhydric alcohol components and polycarboxylic acid components such as polycarboxylic acids, polycarboxylic anhydrides and polycarboxylic acid esters.

In the present invention, the non-crystalline polyester resin refers to those obtained using polyhydric alcohol components and polycarboxylic acid components such as polycarboxylic acids, polycarboxylic anhydrides and polycarboxylic acid esters, as described above. Polyester resins that have been modified; e.g., the below-described binder resin precursor (prepolymer) and modified polyester resins obtained by crosslinking and/or elongating the prepolymer (i.e., modified polyester resins having at least one of a urethane bond and a urea bond) are not encompassed by the non-crystalline polyester resin in the present invention, but are treated as a modified polyester resin.

The polyhydric alcohol component is not particularly limited and may be appropriately selected depending on the intended purpose. Examples thereof include: alkylene(C2-3)oxide adducts of bisphenol A (average addition mol: 1 to 10) such as polyoxypropylene(2,2)-2,2-bis(4-hydroxyphenyl)propane and polyoxyethylene(2,2)-2,2-bis(4-hydroxyphenyl)propane; ethylene glycol, propylene glycol, neopentyl glycol, glycerin, pentaerythritol, trimethylolpropane, hydrogenated bisphenol A, sorbitol and alkylene(C2-3)oxide adducts thereof (average addition mol: 1 to 10). These may be used alone or in combination.

The polycarboxylic acid component is not particularly limited and may be appropriately selected depending on the intended purpose. Examples thereof include: dicarboxylic acids such as adipic acid, phthalic acid, isophthalic acid, terephthalic acid, fumaric acid and maleic acid; substituted succinic acids having as a substituent a C1-20 alkyl group or a C2-20 alkenyl group, such as dodecenyl succinic acid and octyl succinic acid; trimellitic acid and pyromellitic acid; and anhydrides and alkyl(C1-8) esters of these acids. These may be used alone or in combination.

The non-crystalline polyester resin, the below-described binder resin precursor (prepolymer) and modified polyester resins obtained by crosslinking and/or elongating the prepolymer (i.e., modified polyester resins having at least one of a urethane bond and a urea bona) are not particularly limited and may be appropriately selected depending on the intended purpose. They are preferably in an at least partially compatible state, since the formed toner can be increased in low-temperature fixing property and hot offset resistance. Thus, preferably, the non-crystalline polyester resin and the below-described binder resin precursor (prepolymer) are similar in their constituent polyhydric alcohol component and their constituent polycarboxylic acid component.

The glass transition temperature (Tg) of the non-crystalline polyester resin is not particularly limited and may be appropriately selected depending on the intended purpose. It is preferably 55° C. to 65° C., more preferably 57° C. to 62° C. When the glass transition temperature thereof is lower than 55° C., the formed toner may be poor in heat resistance storage stability and durability to stress due to, for example, stirring in the developing device. Whereas when it is higher than 65° C., the formed toner may be increased in viscoelasticity during melting, resulting in that it may be degraded in low-temperature fixing property.

Notably, the glass transition temperature refers to a glass transition temperature measured by differential scanning calorimetry (DSC). The glass transition temperature can be measured using, for example, TG-DSC SYSTEM TAS-100 (product of Rigaku Corporation).

The amount of the non-crystalline polyester resin contained in the toner is not particularly limited and may be appropriately selected depending on the intended purpose, but is preferably 75 parts by mass to 95 parts by mass, more preferably 80 parts by mass to 90 parts by mass, per 100 parts by mass of the toner. When the amount thereof is less than 75 parts by mass, the colorant and the releasing agent are degraded in dispersibility in the toner, easily causing image fogging and image failure. Whereas when it is more than 95 parts by mass, the formed toner may be degraded in low-temperature fixing property since the amount of the crystalline polyester resin becomes small. In addition, the formed toner may be degraded in hot offset resistance since the amount of the modified polyester resin becomes small.

### —Modified Polyester Resin—

The modified polyester resin can provide the toner with an appropriate extent of crosslinked structures. The modified polyester resin is not particularly limited and may be appropriately selected depending on the intended purpose, so long as it is a resin having at least one of a urethane bond and a urea bond. The modified polyester resin is preferably resins obtained through elongating reaction and/or crosslinking reaction between an active hydrogen group-containing compound and a binder resin precursor having a functional group reactive with the active hydrogen group-containing compound (hereinafter, the binder resin precursor may be referred to as “prepolymer”).

The prepolymer is not particularly limited and may be appropriately selected depending on the intended purpose, so long as it is a polyester resin having at least a functional group reactive with the active hydrogen group-containing compound.

The functional group reactive with the active hydrogen group-containing compound in the prepolymer is not particularly limited and may be appropriately selected from known substituents. Examples thereof include an isocyanate group, an epoxy group, carboxylic acid and an acid chloride group. These may be contained alone or in combination. Among them, an isocyanate group is preferred.

The method for synthesizing the prepolymer is not particularly limited and may be appropriately selected depending on the intended purpose. For producing an isocyanate group-containing prepolymer, the following method can be employed, for example. Specifically, a polyol and a polycarboxylic acid are heated to a temperature of 150° C. to 280° C. in the presence of a known esterification catalyst such as tetrabutoxy titanate or dibutyltin oxide. Subsequently, the formed water is removed under reduced pressure if necessary, to prepare a polyester having a hydroxyl group. Thereafter, the thus-prepared polyester is reacted with a polyisocyanate at a temperature of 40° C. to 140° C. to prepare the isocyanate group-containing prepolymer.

The polyol is not particularly limited and may be appropriately selected depending on the intended purpose. Examples thereof include: diols such as alkylene glycols (e.g., ethylene glycol, 1,2-propylene glycol, 1,3-propylene glycol, 1,4-butanediol and 1,6-hexanediol), alkylene ether glycols (e.g., diethylene glycol, triethylene glycol, dipropylene glycol, polyethylene glycol, polypropylene glycol and polytetramethylene ether glycol), alicyclic diols (e.g., 1,4-cyclohexane dimethanol and hydrogenated bisphenol A), bisphenols (e.g., bisphenol A, bisphenol F and bisphenol S), adducts of the above-listed alicyclic diols with alkylene oxides (e.g., ethylene oxide, propylene oxide and butylene oxide); adducts of the above-listed bisphenols with alkylene oxides (e.g., ethylene oxide, propylene oxide and butylene oxide); trihydric or higher polyols such as polyhydric aliphatic alcohols (e.g., glycerin, trimethylolethane, trimethylolpropane, pentaerythritol and sorbitol), trihydric or higher phenols (e.g., phenol novolak and cresol novolak) and alkylene oxide adducts of trihydric or higher polyphenols; and mixtures of diols and trihydric or higher polyols. These may be used alone or in combination.

In particular, the polyol is preferably the above diol alone or mixtures of the above diol and a small amount of the trihydric or higher polyol. The diol is preferably C2-12 alkylene glycols or alkylene oxide adducts of bisphenols (e.g., bisphenol A ethylene oxide 2 mol adducts, bisphenol A propylene oxide 2 mol adducts and bisphenol A propylene oxide 3 mol adducts).

The polycarboxylic acid is not particularly limited and may be appropriately selected depending on the intended purpose. Examples thereof include: alkylene dicarboxylic acids (e.g., succinic acid, adipic acid and sebacic acid); alkenylene dicarboxylic acids (e.g., maleic acid and fumaric acid); aromatic dicarboxylic acids (e.g., terephthalic acid, isophthalic acid, and naphthalene dicarboxylic acid); and tri- or higher-valent polycarboxylic acids (e.g., C9-20 aromatic polycarboxylic acids such as trimellitic acid and pyromellitic acid). These may be used alone or in combination.

Among them, the polycarboxylic acid is preferably a C4-20 alkenylene dicarboxylic acid or a C8-C20 aromatic dicarboxylic acid.

Notably, the polycarboxylic acid used may be an anhydride thereof or a lower alkyl ester thereof (e.g., methyl ester, ethyl ester or isopropyl ester).

The mixing ratio between the polyol and the polycarboxylic acid is not particularly limited and may be appropriately selected depending on the intended purpose. The mixing ratio therebetween is preferably 2/1 to 1/1, more preferably 1.5/1 to 1/1, particularly preferably 1.3/1 to 1.02/1, in terms of the equivalent ratio [OH]/[COOH] of the hydroxyl group [OH] of the polyol to the carboxyl group [COOH] the polycarboxylic acid.

The polyisocyanate is not particularly limited and may be appropriately selected depending on the intended purpose. Examples thereof include: aliphatic polyisocyanates (e.g., tetramethylene diisocyanate, hexamethylene diisocyanate and 2,6-diisocyanatomethylcaproate, octamethylene diisocyanate, decamethylene diisocyanate, dodecamethylene diisocyanate, tetradecamethylene diisocyanate, trimethylhexane diisocyanate and tetramethylhexane diisocyanate); alicyclic polyisocyanates (e.g., isophoron diisocyanate and cyclohexylmethane diisocyanate); aromatic diisocyanates (e.g., tolylene diisocyanate and diphenylmethane diisocyanate, 1,5-naphthylene diisocyanate, diphenylene-4,4′-diisocyanate, 4,4′-diisocyanato-3,3′-dimethylphenyl, 3-methyldiphenylmethane-4,4-diisocyanate and diphenylether-4,4′-diisocyanate); aromatic aliphatic diisocyanates (e.g., α,α,α′,α′-tetramethylxylylene diisocyanate); isocyanurates (e.g., tris-isocyanatoalkyl-isocyanurate, triisocyanatocycloalkyl-isocyanurate); phenol derivatives thereof, and blocked products thereof with, for example, oxime or caprolactam. These may be used alone or in combination.

When reacting the polyisocyanate with the hydroxyl group-containing polyester, a solvent may be used if necessary. The solvent usable is not particularly limited and may be appropriately selected depending on the intended purpose. Examples thereof include solvents inert to an isocyanate such as aromatic solvents (e.g., toluene and xylene); ketones (e.g., acetone, methyl ethyl ketone and methyl isobutyl ketone); esters (e.g., ethyl acetate); amides (e.g., dimethylformamide and dimethylacetamide); ethers (e.g., tetrahydrofuran). These may be used alone or in combination.

The mixing ratio between the polyisocyanate and the hydroxyl group-containing polyester is not particularly limited and may be appropriately selected depending on the intended purpose. The mixing ratio therebetween is preferably 5/1 to 1/1, more preferably 4/1 to 1.2/1, particularly preferably 2.5/1 to 1.5/1, in terms of the equivalent ratio [NCO]/[OH] of the isocyanate group [NCO] of the polyisocyanate to the hydroxyl group [OH] of the polyester. When the equivalent ratio [NCO]/[OH] is more than 5, the remaining polyisocyanate compound may adversely affect the chargeability of the formed toner.

### —Active Hydrogen Group-Containing Compound—

The active hydrogen group-containing compound acts, in an aqueous medium, as an elongating agent or crosslinking agent at the time of the elongating reaction or crosslinking reaction of the prepolymer.

The active hydrogen group is not particularly limited and may be appropriately selected depending on the intended purpose. Examples thereof include a hydroxyl group (e.g., an alcoholic hydroxyl group or a phenolic hydroxyl group), an amino group, a carboxyl group and a mercapto group. These may be contained alone or in combination.

The active hydrogen group-containing compound is not particularly limited and may be appropriately selected depending on the intended purpose. Examples thereof include water. In cases where the prepolymer is an isocyanate group-containing polyester prepolymer, amines are preferably used from the viewpoint of increasing the molecular weight of the reaction product.

The amines serving as the active hydrogen group-containing compound are not particularly limited and may be appropriately selected depending on the intended purpose. Examples thereof include diamines, tri- or higher-valent polyamines, amino alcohols, amino mercaptans, amino acids, and compounds obtained by blocking the amino groups of these amines. Examples of the diamines include aromatic diamines (e.g., phenylenediamine, diethyltoluenediamine and 4,4′-diaminodiphenylmethane); alicyclic diamines (e.g., 4,4′-diamino-3,3′-dimethyldicyclohexylmethane, diaminecyclohexane and isophoronediamine); and aliphatic diamines ethylenediamine, tetramethylenediamine and hexamethylenediamine). Examples of the tri- or higher-valent polyamines include diethylenetriamine and triethylenetetramine. Examples of the amino alcohols include ethanolamine and hydroxyethylaniline. Examples of the amino mercaptans include aminoethyl mercaptan and aminopropyl mercaptan. Examples of the amino acids include aminopropionic acid and aminocaproic acid. Examples of the compounds obtained by blocking the amino groups of the above amines include oxazoline compounds and ketimine compounds obtained from any of the above amines (i.e., diamines, tri- or higher-valent polyamines, amino alcohols, amino mercaptans and amino acids) and ketones (e.g., acetone, methyl ethyl ketone and methyl isobutyl ketone). These may be used alone or in combination.

Among them, the amines are particularly preferably diamines and mixtures of diamines and a small amount of tri- or higher-valent polyamines.

The active hydrogen group-containing compound and the prepolymer are allowed to undergo the elongating reaction and/or crosslinking reaction in an aqueous medium, to thereby obtain the modified polyester resin.

The elongating reaction and/or crosslinking reaction may be terminated using a reaction terminator such as a monoamine (e.g., diethylamine, dibutylamine, butylamine or laurylamine) or a compound obtained by blocking the monoamine (e.g., a ketimine compound).

In the synthesis of the modified polyester resin, the mixing ratio between the isocyanate group-containing polyester serving as the prepolymer and the amine serving as the active hydrogen group-containing compound is not particularly limited and may be appropriately selected depending on the intended purpose. The equivalent ratio [NCO]/[NHx] of the isocyanate group [NCO] of the isocyanate group-containing polyester to the amino group [NHx] of the amine is preferably 1/2 to 2/1, more preferably 1/1.5 to 1.5/1, particularly preferably 1/1.2 to 1.2/1.

### —Other Resins—

The other resins are not particularly limited and may be appropriately selected depending on the intended purpose. Examples thereof include styrene-acryl copolymer resins, polyol resins, vinyl resins, polyurethane resins, epoxy resins, polyamide resins, polyimide resins, silicon-containing resins, phenol resins, melamine resins, urea resins, aniline resins, ionomer resins and polycarbonate resins. These may be used alone or in combination.

### <Colorant>

The colorant is not particularly limited and may be any known dyes or pigments. Examples of the colorant include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and dxcGR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower, lithopone, and mixtures thereof. These colorants may be used alone or in combination.

The amount of the colorant is preferably 1% by mass to 15% by mass, more preferably 3% by mass to 10% by mass, relative to the toner.

The colorant may be mixed with a resin to form a masterbatch. Examples of the resin which is used for producing a masterbatch or which is kneaded together with a masterbatch include the above-described modified or unmodified polyester resins; styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers); polymethyl methacrylate resins; polybutyl methacrylate resins; polyvinyl chloride resins; polyvinyl acetate resins; polyethylene resins; polypropylene resins, polyester resins; epoxy resins; epoxy polyol resins; polyurethane resins; polyamide resins; polyvinyl butyral resins; polyacrylic acid resins; rosin; modified rosin; terpene resins; aliphatic or alicyclic hydrocarbon resins; aromatic petroleum resins; chlorinated paraffins; and paraffin waxes. These may be used alone or in combination.

The masterbatch can be prepared by mixing and kneading a colorant with a resin for use in a masterbatch through application of high shearing force. An organic solvent may also be used for improving interactions between the colorant and the resin. Furthermore, the flashing method, in which an aqueous paste containing a colorant is mixed and kneaded with a resin and an organic solvent and then the colorant is transferred to the resin to remove water and the organic solvent, is preferably used, since a wet cake of the colorant can be directly used (i.e., no drying is required). For this mixing and kneading, a high-shearing dispersing device (e.g., a three-roll mill) is preferably used.

### <Other Ingredients>

The other ingredients are not particularly limited and may be appropriately selected depending on the intended purpose. Examples thereof include a charge-controlling agent, fine inorganic particles, a flowability-improving agent, a cleanability-improving agent and a magnetic material.

### —Charge Controlling Agent—

The charge controlling agent is not particularly limited and may be appropriately selected depending on the intended purpose. Examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluoroactive agents, metal salts of salicylic acid, and metal salts of salicylic acid derivatives.

Specific examples thereof include nigrosine dye BONTRON 03, quaternary ammonium salt BONTRON P-51, metal-containing azo dye BONTRON S-34, oxynaphthoic acid metal complex E-82, salicylic acid metal complex E-84 and phenol condensate E-89 (these products are of ORIENT CHEMICAL INDUSTRIES CO., LTD), quaternary ammonium salt molybdenum complexes TP-302 and TP-415 (these products are of Hodogaya Chemical Co., Ltd.), quaternary ammonium salt COPY CHARGE PSY VP 2038, triphenylmethane derivative COPY BLUE PR, quaternary ammonium salt COPY CHARGE NEG VP2036 and COPY CHARGE NX VP434 (these products are of Hoechst AG), LRA-901 and boron complex LR-147 (these products are of Japan Carlit Co., Ltd.), copper phthalocyanine, perylene, quinacridone, azo pigments, and polymeric compounds having, as a functional group, a sulfonic acid group, a carboxyl group and/or a quaternary ammonium salt.

The amount of the charge-controlling agent is not determined flatly and is varied depending on the type of the binder resin used, on an optionally used additive, and on the toner production method used (including the dispersion method used). The amount of the charge controlling agent is preferably 0.1 parts by mass to 10 parts by mass, more preferably 0.2 parts by mass to 5 parts by mass, per 100 parts by mass of the binder resin. When the amount thereof is more than 10 parts by mass, the formed toner has too high chargeability, resulting in that the charge controlling agent exhibits reduced effects. As a result, the electrostatic attractive force increases between the developing roller and the toner, decreasing the flowability of the toner and forming an image with reduced color density. The charge controlling agent may be melt-kneaded together with a masterbatch or resin, and then dissolved or dispersed. Needless to say, the charge controlling agent may be added to an organic solvent when it is dissolved or dispersed therein; or may be fixed on the surfaces of the formed toner particles.

### —Fine Inorganic Particles—

The fine inorganic particles may be used as an external additive for providing toner particles with flowability, developability and chargeability.

The fine inorganic particles are not particularly limited and may be appropriately selected depending on the intended purpose. Examples thereof include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride. These may be used alone or in combination.

Further examples of the fine inorganic particles include polystyrenes, methacrylic acid esters, acrylate ester copolymers, polycondensates of, for example, silicone, benzoguanamine and nylon, and polymer particles of thermosetting resins, which are produced through soap-free emulsion polymerization, suspension polymerization and dispersion polymerization.

The primary particle diameter of the fine inorganic particles is preferably 5 nm to 2 μm, more preferably 5 nm to 500 nm. The specific surface area of the fine inorganic particles as measured with the BET method is preferably 20 m²/g to 500 m²/g.

The amount of the fine inorganic particles is preferably 0.01% by mass to 5% by mass, more preferably 0.01% by mass to 2.0% by mass.

The flowability-improving agent refers to a compound which has increased hydrophobicity through a surface treatment and can prevent the toner from being degraded in flowability and chargeability even under high-humidity conditions. Examples thereof include silane coupling agents, silylating agents, fluorinated alkyl group-containing silane coupling agents, organic titanate-containing coupling agents, aluminum-containing coupling agents, silicone oil and modified silicone oil.

### —Cleanability-Improving Agent—

The cleanability-improving agent is added to the toner for removing the developer remaining after transfer on a latent electrostatic image bearing member and a primary recording medium. Examples of the cleanability-improving agent include metal salts of fatty acids such as stearic acid (e.g., zinc stearate and calcium stearate), fine polymer particles formed by soap-free emulsion polymerization, such as fine polymethylmethacrylate particles and fine polystylene particles. The fine polymer particles preferably have a relatively narrow particle size distribution. It is preferable that the volume average particle diameter thereof be 0.01 μm to 1 μm.

### —Magnetic Material—

The magnetic material is not particularly limited and may be appropriately selected depending on the intended purpose. Examples thereof include iron powder, magnetite and ferrite. The magnetic material is preferably white in terms of color tone.

### <Method for Producing Toner>

The method for producing a toner is a method for producing the toner of the present invention where an oil phase which is obtained by dissolving or dispersing in an organic solvent an active hydrogen group-containing compound, a binder resin precursor having a site reactive with the active hydrogen group-containing compound, a crystalline polyester resin, a colorant and an ester wax, is dispersed in an aqueous medium to prepare an emulsified dispersion liquid where the binder resin precursor and the active hydrogen group-containing compound are allowed to react in the emulsified dispersion liquid, and then the organic solvent is removed. Specifically, the above method includes: an oil phase preparation step; an aqueous phase preparation step; a toner dispersing liquid preparation step; and a solvent removal step; and, if necessary, further include other steps.

### <<Oil Phase Preparation Step>>

The oil phase preparation step is not particularly limited and may be appropriately selected depending on the intended purpose, so long as it is a step of dissolving or dispersing in an organic solvent an active hydrogen group-containing compound, a binder resin precursor having a site reactive with the active hydrogen group-containing compound, a crystalline polyester resin, a colorant and an ester wax, to thereby prepare an oil phase.

The method for preparing the oil phase is, for example, a method where the active hydrogen group-containing compound, the binder resin precursor having a site reactive with the active hydrogen group-containing compound, the crystalline polyester resin, the colorant, the ester wax, and an optionally-used charge-controlling agent are gradually added to the organic solvent under stirring so that these materials are dissolved or dispersed therein.

Notably, when a pigment is used as the colorant and/or when materials poorly dissolvable to the organic solvent such as the charge controlling agent are used, the particles of these materials are preferably micronized before the addition to the organic solvent.

As described above, the colorant may be formed into a masterbatch. Similarly, the ester wax and the charge controlling agent may be formed into a masterbatch.

In another method, the colorant, the ester wax and the charge-controlling agent may be dispersed through a wet process in the organic solvent, if necessary in the presence of a dispersion aid, to thereby obtain a wet master.

In still another method, when dispersing the materials melted at a temperature lower than the boiling point of the organic solvent, they are heated and dissolved under stirring in the organic solvent, if necessary in the presence of a dispersion aid, and stirred together with the dispersoids; and the resultant solution is cooled with stirring or shearing so that the dissolved materials are crystallized, to thereby produce microcrystals of the dispersoids.

After the colorant, the ester wax and the optionally-used charge-controlling agent, dispersed with any of the above methods, have been dissolved or dispersed in the organic solvent together with the active hydrogen group-containing compound, the binder resin precursor having a site reactive with the active hydrogen group-containing compound, and the crystalline polyester resin, the resultant mixture may be further dispersed. The dispersion may be performed using a known disperser such as a bead mill or a disc mill.

In order for the toner to have an increased mechanical strength and involve no hot offset upon fixing, the toner is preferably produced in a state where the binder resin precursor having a functional group reactive with the active hydrogen group-containing compound is dissolved in the oil phase; in other words, in a state where the oil phase contains the active hydrogen group-containing compound and the binder resin precursor.

The organic solvent used in the oil phase preparation step is not particularly limited and may be appropriately selected depending on the intended purpose. The organic solvent used preferably has a boiling point lower than 100° C. from the viewpoint of being easily removed. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used alone or in combination.

When the binder resin to be dissolved or dispersed in the organic solvent has a polyester skeleton, preferably used are ester solvents (e.g., methyl acetate, ethyl acetate and butyl acetate) or ketone solvents (e.g., methyl ethyl ketone and methyl isobutyl ketone) since these solvents have high dissolution capability to the binder resin having a polyester skeleton. Among them, methyl acetate, ethyl acetate and methyl ethyl ketone are particularly preferred since these can be removed more easily.

### <<Aqueous Phase Preparation Step>>

The aqueous phase preparation step is not particularly limited and may be appropriately selected depending on the intended purpose, so long as it is a step of preparing an aqueous phase.

The aqueous medium used in the aqueous phase preparation step is not particularly limited and may be appropriately selected depending on the intended purpose. Examples thereof include water. The aqueous medium may be water alone or a mixture of water and a water-miscible organic solvent. Examples of the water-miscible organic solvent include alcohols (e.g., methanol, isopropanol and ethylene glycol), dimethylformamide, tetrahydrofuran, cellosolves (e.g., methyl cellosolve) and lower ketones (e.g., acetone and methyl ethyl ketone).

Preferably, the aqueous medium further contains a surfactant.

The surfactant is not particularly limited and may be appropriately selected depending on the intended purpose. Examples thereof include anionic surfactants such as alkylbenzenesulfonic acid salts, α-olefin sulfonic acid salts, phosphoric acid esters and disulfonic acid salts; cationic surfactants such as amine salts (e.g., alkyl amine salts, aminoalcohol fatty acid derivatives, polyamine fatty acid derivatives and imidazoline) and quaternary ammonium salts (e.g., alkyltrimethylammonium salts, dialkyl dimethylammonium salts, alkyl dimethyl benzyl ammonium salts, pyridinium salts, alkyl isoquinolinium salts and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine. Among them, a disulfonic acid salt having a relatively high HLB is preferably used, in order to efficiently disperse the oil droplets containing the solvent.

The amount of the surfactant contained in the aqueous medium is not particularly limited and may be appropriately selected depending on the intended purpose. The amount thereof is preferably 3% by mass to 10% by mass, more preferably 4% by mass to 9% by mass, particularly preferably 5% by mass to 8% by mass. When the amount thereof is lower than 3% by mass, the oil droplets cannot be stably dispersed and as a result coarse oil droplets may be formed. Whereas when it is more than 10% by mass, each oil droplet becomes too small and also has a reverse micellar structure. Thus, the dispersion stability is degraded due to the surfactant added in such an amount, to thereby easily form coarse oil droplets.

### <<Toner Dispersion Liquid Preparation Step>>

The toner dispersion liquid preparation step is not particularly limited and may be appropriately selected depending on the intended purpose, so long as it is a step of dispersing the oil phase in the aqueous phase to prepare an emulsified dispersion liquid (toner dispersion liquid).

The method for the dispersing is not particularly limited and may be appropriately selected depending on the intended purpose. It may use a known disperser such as a low-speed shearing disperser, a high-speed shearing disperser, a friction disperser, a high-pressure jet disperser or an ultrasonic disperser. Among them, a high-speed shearing disperser is preferably used to form toner base particles having a particle diameter of 2 μm to 20 μm. The rotation speed of the high-speed shearing disperser is not particularly limited but is preferably 1,000 rpm to 30,000 rpm, more preferably 5,000 rpm to 20,000 rpm. The dispersion time is not particularly limited and may be appropriately selected depending on the intended purpose, but is preferably 0.1 min to 5 min in a batch method. When the dispersion time exceeds 5 min, unwanted small particles remain and excessive dispersion is performed to make the dispersion system unstable, potentially forming aggregates and coarse particles. The dispersion temperature is not particularly limited and may be appropriately selected depending on the intended purpose. It is preferably 0° C. to 40° C., more preferably 10° C. to 30° C. When the dispersion temperature is lower than 0° C., the dispersion liquid is increased in viscosity to require elevated energy for dispersion, leading to a drop in production efficiency. Whereas when the dispersion temperature exceeds 40° C., molecular movements are excited to degrade dispersion stability, easily forming aggregates and coarse particles.

The amount of the organic solvent contained in the toner dispersion liquid is not particularly limited and may be appropriately selected depending on the intended purpose. It is preferably 10% by mass to 70% by mass, more preferably 25% by mass to 60% by mass, particularly preferably 40% by mass to 55% by mass.

Notably, the amount of the organic solvent contained in the toner dispersion liquid is an amount relative to the solid content (e.g., the binder resin, the colorant, the ester wax and the optionally-used charge-controlling agent) in the state of the toner dispersion liquid.

### <<Solvent Removal Step>>

The solvent removal step is not particularly limited and may be appropriately selected depending on the intended purpose, so long as it is a step of removing the solvent contained in the toner dispersion liquid. The solvent removal step is preferably a step of completely removing the solvent contained in the toner dispersion liquid. In one employable method, the toner dispersion liquid is gradually increased in temperature under stirring, to thereby completely evaporate off the organic solvent contained in the liquid droplets. In another employable method, the toner dispersion liquid under stirring is sprayed toward a dry atmosphere, to thereby completely evaporate off the organic solvent contained in the liquid droplets. In still another employable method, the toner dispersion liquid is reduced in pressure under stirring to evaporate off the organic solvent. The latter two means may be used in combination with the first means.

The dry atmosphere toward which the toner dispersion liquid is sprayed is not particularly limited and may be appropriately selected depending on the intended purpose. The dry atmosphere uses heated gas such as air, nitrogen, carbon dioxide or combustion gas.

The temperature of the dry atmosphere is not particularly limited and may be appropriately selected depending on the intended purpose, but is preferably a temperature equal to or higher than the highest boiling point of the solvents used.

The spraying is performed using, for example, a spray dryer, a belt dryer or a rotary kiln. Use thereof can provide satisfactory intended qualities through treatment even in a short time.

### <<Other Steps>>

The other steps are not particularly limited and may be appropriately selected depending on the intended purpose. Examples thereof include an aging step, a washing step and a drying step.

### —Aging Step—

When the oil phase contains the polyester resin (prepolymer) containing a functional group reactive with the active hydrogen group of the active hydrogen group-containing compound, the aging step is preferably performed for proceeding the elongating and crosslinking reaction the prepolymer.

The aging step is preferably performed after the solvent removal step but before the washing step.

The aging time in the aging step is not particularly limited and may be appropriately selected depending on the intended purpose, but is preferably 10 min to 40 hours, more preferably 2 hours to 24 hours.

The reaction temperature in the aging step is not particularly limited and may be appropriately selected depending on the intended purpose, but is preferably 0° C. to 65° C., more preferably 35° C. to 50° C.

### —Washing Step—

The washing step is not particularly limited and may be appropriately selected depending on the intended purpose, so long as it is a step performed after the solvent removal step or the aging step and washing a toner (toner base particles) contained in the toner dispersion liquid.

The toner dispersion liquid contains not only the toner base particles but also such subsidiary materials as the dispersing agent (e.g., the surfactant). Thus, the dispersion liquid is washed to separate only the toner base particles from the toner dispersion liquid.

The washing method is not particularly limited and may be appropriately selected depending on the intended purpose. Examples thereof include a centrifugation method, a reduced-pressure filtration method and a filter press method. Any of the above methods forms a cake of the toner base particles. When the toner base particles are not sufficiently washed through only one washing process, the formed cake may be dispersed again in an aqueous medium to form a slurry, which is repeatedly treated with any of the above methods to taken out the toner base particles. When a reduced-pressure filtration method or a filter press method is employed for washing, an aqueous medium may be made to penetrate the cake to wash out the subsidiary materials contained in the toner base particles. The aqueous medium used for the washing is water or a solvent mixture of water and an alcohol such as methanol or ethanol. Water is preferably used from the viewpoint of reducing cost and environmental load caused by, for example, drainage treatment.

### —Drying Step—

The drying step is not particularly limited and may be appropriately selected depending on the intended purpose, so long as it is a step performed after the washing step and drying the toner base particles.

The washed toner base particles containing a large amount of are dried to remove the water, whereby only the toner base particles can be obtained.

The method of removing water from the toner base particles is not particularly limited and may be appropriately selected depending on the intended purpose. The method uses, for example, a spray dryer, a vacuum freezing dryer, a reduced-pressure dryer, a ventilation shelf dryer, a movable shelf dryer, a fluidized-bed-type dryer, a rotary dryer or a stirring-type dryer.

The toner base particles are preferably dried until the water content thereof is finally decreased less than 1% by mass. Also, when the dry toner base particles flocculate to cause inconvenience in use, the flocculated particles may be separated from each other through beating using, for example, a jet mill, HENSCHEL MIXER, a super mixer, a coffee mill, an oster blender or a food processor.

### (Developer)

A developer of the present invention contains the toner of the present invention, and may further contain other components such as a carrier. It may be, for example, a one-component developer containing only the toner, or a two-component developer containing the toner and the carrier. When used in, for example, high-speed printers which respond to an increase in the recent information processing speed, the developer is preferably used as a two-component developer from the viewpoint of elongating its service life. Such a developer may be used for various known electrophotographies such as a magnetic one-component developing method, a non-magnetic one-component developing method and a two-component developing method.

When used as a one-component developer, the developer of the present invention involves less change in diameter of each toner particle even after repetitive cycles of consumption and addition thereof, which prevents toner filming on a developing roller and toner adhesion on surrounding members such as a blade for forming a thin toner layer. Thus, even when used (stirred) in a developing device for a long period of time, the developer maintains stable, excellent developability.

Also, when used as a two-component developer, the developer of the present invention involves less change in diameter of each toner particle even after long-term repetitive cycles of consumption and addition thereof. Thus, even when stirred in a developing device for a long period of time, the developer maintains stable, excellent developability.

The amount of the carrier contained in the two-component developer is preferably 90% by mass to 98% by mass, more preferably 93% by mass to 97% by mass.

The carrier is not particularly limited and may be appropriately selected depending on the intended purpose, but preferably has a core and a resin layer covering the core.

Examples of the material for the core include manganese-strontium (Mn—Sr) materials (50 emu/g to 90 emu/g) and manganese-magnesium (Mn—Mg) materials (50 emu/g to 90 emu/g). These may be used alone or in combination. Notably, from the viewpoint of ensuring desired image density, strongly magnetized materials (e.g., iron powder (100 emu/g or higher) and magnetite (75 emu/g to 120 emu/g)) are preferably used as the core. Meanwhile, from the viewpoint of advantageously attaining high image quality and weakening impact on the photoconductor on which toner particles are retained in the chain-like form, weakly magnetized materials (e.g., copper-zinc (Cu—Zn) materials (30 emu/g to 80 emu/g)) are preferably used as the core.

The core preferably has a volume average particle diameter (D50) of 10 μm to 150 μm, more preferably 20 μm to 80 μm. When the D50 is smaller than 10 μm, the carrier has a particle size distribution most of which correspond to fine powder. Thus, the magnetization per particle decreases, potentially causing carrier scattering. Whereas when the D50 is greater than 150 μm, the specific surface area of the carrier decreases, potentially causing toner scattering. As a result, in the case of full color images having a large solid portion, the reproducibility may degrade in, among others, the solid portion.

The material for the resin layer is not particularly limited and may be appropriately selected depending on the intended purpose. Examples thereof include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, copolymers formed of vinylidene fluoride and an acrylic monomer, copolymers formed of vinylidene fluoride and vinyl fluoride, fluoroterpolmers such as terpolymers formed of tetrafluoroethylene, vinylidene fluoride and a non-fluorinated monomer, and silicone resins. These may be used alone or in combination.

Examples of the amino resins include urea-formaldehyde resins, melamine resins, benzoguanamine resins, urea resins, polyamide resins and epoxy resins. Examples of the polyvinyl resins include acrylic resins, polymethyl mathacrylate, polyacrylonitrile, polyvinyl acetate, polyvinyl alcohol and polyvinyl butyral. Examples of the polystyrene resins include polystyrene and styrene-acrylic copolymers. Examples of the halogenated olefin resins include polyvinyl chloride. Examples of the polyester resins include polyethylene terephthalate and polybutylene terephthalate.

If necessary, the resin layer may further contain, for example, electrically conductive powder. Examples of the material for the electrically conductive powder include metals, carbon black, titanium oxide, tin oxide and zinc oxide. The average particle diameter of the electrically conductive powder is not particularly limited and is preferably 1 μm or smaller. When the average particle diameter is more than 1 electrical resistance may be difficult to control.

The resin layer may be formed, for example, as follows. Specifically, a silicone resin and other materials are dissolved in a solvent to prepare a coating liquid, and then the thus-prepared coating liquid is applied onto the core surface with a known coating method, followed by drying and baking. Examples of the coating method include immersion methods, spray methods and brush coating methods. Examples of the solvent include toluene, xylene, methyl ethyl ketone, methyl isobutyl ketone and cellosolve acetate. The baking method may be an external or internal heating method. Examples thereof include methods employing a fixed-type electric furnace, a fluid-type electric furnace, a rotary electric furnace or a burner furnace; and methods employing microwave radiation.

The amount of the resin layer contained in the carrier is preferably 0.01% by mass to 5.0% by mass. When the amount is less than 0.01% by mass, a uniform resin layer cannot be formed on the surface of a carrier in some cases. Whereas when the amount thereof is more than 5.0% by mass, the formed resin layer becomes too thick to cause adhesion between carrier particles, potentially resulting in failure to form uniform carrier particles.

The developer of the present invention may be suitably used in image formation by various known electrophotographies such as a magnetic one-component developing method, a non-magnetic one-component developing method and a two-component developing method.

### <Developer-Accommodating Container>

A developer-accommodating container used in the present invention accommodates the developer of the present invention.

The container thereof is not particularly limited and may be appropriately selected from known containers. Examples thereof include those having a cap and a container main body.

The size, shape, structure and material of the container main body are not particularly limited and may be appropriately selected depending on the intended purpose. The container main body preferably has, for example, a hollow-cylindrical shape. Particularly preferably, it is a hollow-cylindrical body whose inner surface has spirally-arranged concavo-convex portions some or all of which can accordion and in which the developer accommodated can be transferred to an outlet port through rotation.

The material for the developer-accommodating container is not particularly limited and is preferably those from which the container main body can be formed with high dimensional accuracy. Among them, resins are preferably used, and examples of preferable resins include polyester resins, polyethylene resins, polypropylene resins, polystyrene resins, polyvinyl chloride resins, polyacrylic acids, polycarbonate resins, ABS resins and polyacetal resins.

The above developer-accommodating container has excellent handleability; i.e., is suitable for storage, transportation, and is suitably used for supply of a developer with being detachably mounted to, for example, the below-described process cartridge and image forming apparatus.

### (Image Forming Apparatus and Image Forming Method)

An image forming apparatus of the present invention includes a latent electrostatic image bearing member, a charging unit, an exposing unit, a developing unit, a transfer unit and a fixing unit; and, if necessary, further includes appropriately selected other units such as a charge-eliminating unit, a cleaning unit, a recycling unit and a controlling unit. Notably, the charging unit and the exposing unit are collectively referred to as “latent electrostatic image forming unit.”

An image forming method of the present invention includes a charging step, an exposing step, a developing step, a transfer step and a fixing step; and, if necessary, further includes appropriately selected other steps such as a charge-eliminating step, a cleaning step, a recycling step and a controlling step. Notably, the charging step and the exposing step are collectively referred to as “latent electrostatic image forming step.”

The image forming method of the present invention can suitably be performed by the image forming apparatus of the present invention, where the charging step can be performed by the charging unit, the exposing step can be performed by the exposing unit, the developing step can be performed by the developing unit, the transfer step can be performed by the transfer unit, the fixing step can be performed by the fixing unit, and the other steps can be performed by the other units.

### <Latent Electrostatic Image Bearing Member>

The material, shape, structure and size of the latent electrostatic image bearing member (hereinafter may be referred to as “electrophotographic conductor” or “photoconductor”) are not particularly limited and may be appropriately selected from those known in the art. Regarding the shape, the latent electrostatic image bearing member is suitably in the form of a drum. Regarding the material, the latent electrostatic image bearing member is, for example, an inorganic photoconductor made of amorphous silicon or selenium and an organic photoconductor made of polysilane or phthalopolymethine. Among them, an amorphous silicon photoconductor is preferred since it has a long service life.

The amorphous silicon photoconductor may be, for example, a photoconductor having a support and an electrically photoconductive layer of a-Si, which is formed on the support heated to 50° C. to 400° C. with a film forming method such as vacuum vapor deposition, sputtering, ion plating, thermal CVD, photo-CVD or plasma CVD (hereinafter this photoconductor may be referred to as “a-Si photoconductor”). Among them, plasma CVD is suitably employed, in which gaseous raw materials are decomposed through application of direct current or high-frequency or microwave glow discharge to form an a-Si deposition film on the support.

### <Charging Step and Charging Unit>

The charging step is a step charging a surface of the latent electrostatic image bearing member and performed by a charging unit.

The charging can be performed by, for example, applying voltage to the surface of the latent electrostatic image bearing member using a charging device.

The charging device is not particularly limited and may be appropriately selected depending on the intended purpose. Examples thereof include contact-type charging devices known per se having, for example, an electrically conductive or semiconductive roller, brush, film and rubber blade; and non-contact-type charging devices utilizing colona discharge such as corotron and scorotron.

The charging member may have any shape like a charging roller as well as a magnetic brush or a fur brush. The shape thereof may be suitably selected according to the specification or configuration of the electrophotographic image forming apparatus used. When the magnetic brush is used, it is composed of; a charging means of various ferrite particles such as Zn—Cu ferrite; a non-magnetic electrically conductive sleeve to support the ferrite particles; and a magnetic roller included in the non-magnetic conductive sleeve. Also, when the fur brush is used, it may be a fur which is treated to be electrically conductive with, for example, carbon, copper sulfide, a metal or a metal oxide as well as which is coiled around or mounted to a metal or a metal core treated to be electrically conductive.

The charging device is not limited to the aforementioned contact-type charging devices. However, the contact-type charging devices are preferably used from the viewpoint of producing an image forming apparatus in which the amount of ozone generated from the charging devices is reduced.

The charging device is preferably one superposingly applying both DC and AC voltages onto the latent electrostatic image bearing member, with disposed so as to be in contact or non-contact therewith.

Also, the charging device is preferably a charging roller which charges the latent electrostatic image bearing member by superposingly applying both DC and AC voltages to the latent electrostatic image bearing member, with disposed proximately thereto via a gap tape; i.e., in a non-contact manner.

### <Exposing Step and Exposing Unit>

The exposing step is a step developing a surface of the charged latent electrostatic image bearing member and performed by the exposing unit.

The exposing can be performed by, for example, imagewise exposing the surface of the latent electrostatic image bearing member to light using the exposing unit.

The optical system in the exposing is roughly classified into an analog optical system and a digital optical system. The analog optical system is an optical system in which a manuscript is directly projected onto a latent electrostatic image bearing member. The digital optical system is an optical system in which image information is given as electrical signals which are then converted into light signals, and a latent electrostatic image bearing member is exposed to the light signals to form an image.

The exposing unit is not particularly limited and may be appropriately selected depending on the purpose, so long as it attains desired imagewise exposure on the surface of the latent electrophotographic image bearing member charged with the charging unit. Examples thereof include various exposing devices such as a copy optical exposing device, a rod lens array exposing device, a laser optical exposing device, a liquid crystal shutter exposing device, and an LED optical exposing device.

In the present invention, light may be imagewise applied from the side facing the support of the latent electrostatic image bearing member.

### <Developing Step and Developing Unit>

The developing step is a step of developing the latent electrostatic image with the toner or developer of the present invention to form a visible image.

The visible image can be formed with the developing unit by, for example, developing the latent electrostatic image using the toner or developer of the present invention.

The developing unit is not particularly limited and may be appropriately selected from known developing units, so long as it attains developing with the toner or developer of the present invention. For example, the developing unit is preferably one having a developing device which contains the toner or developer of the present invention and which can apply the toner or developer to the latent electrostatic image in a contact or non-contact manner. The developing unit is more preferably a developing device containing the toner-accommodating container of the present invention.

The above developing device may employ a dry or wet developing process, and may be a single-color or multi-color developing device. For example, the developing device is preferably one having a rotatable magnetic roller and a stirrer for charging the toner or developer with friction generated during stirring.

In the developing device, toner particles and carrier particles are stirred and mixed so that the toner particles are charged by friction generated therebetween. The charged toner particles are retained in the chain-like form on the surface of the rotating magnetic roller to form magnetic brushes. The magnetic roller is disposed proximately to the latent electrostatic image developing member (photoconductor) and thus, some of the toner particles forming the magnetic brushes on the magnet roller are transferred onto the surface of the latent electrostatic image developing member (photoconductor) by the action of electrically attractive force. As a result, the latent electrostatic image is developed with the toner particles to form a visual toner image on the surface of the latent electrostatic image developing member (photoconductor).

The developer contained in the developing device is a developer containing the toner of the present invention. The developer may be a one-component developer or a two-component developer. The toner contained in the developer is the toner of the present invention.

### <Transfer Step and Transfer Unit>

The transfer step is a step of transferring the visible images to a recording medium. In this step, preferably, the visible images are primarily transferred to an intermediate transfer member, and the thus-transferred visible images are secondarily transferred to the recording medium. Also, toners of two or more colors are used; preferably, a full color toner is used. More preferably, the transfer step includes: a primary transfer step of transferring the visible images to an intermediate member to form a composite transfer image; and a secondary transfer step of transferring the composite transfer image to a recording medium.

For example, the transferring of the visible images can De performed with the transfer unit by charging the latent electrostatic image bearing member (photoconductor) with a transfer charger. Preferably, the transfer unit includes: a primary transfer unit configured to transfer the visible images to an intermediate member to form a composite transfer image; and a secondary transfer unit configured to transfer the composite transfer image onto a recording medium.

The intermediate transfer member is not particularly limited and may be appropriately selected from known transfer members depending on the intended purpose. For example, the intermediate transfer member is preferably a transferring belt.

The transfer unit (including the primary- and secondary transfer units) preferably includes at least a transfer device which transfers the visible images from the latent electrostatic image bearing member (photoconductor) onto the recording medium. The number of the transfer units may be one or two or more. Examples of the transfer device include a corona transfer device employing corona discharge, a transfer belt, a transfer roller, a pressing transfer roller and an adhesive transferring device.

The recording medium is not particularly limited and may be appropriately selected depending on the purpose, so long as it can receive a developed, unfixed image. Examples of the recording medium include plain paper and a PET base for OHP, with plain paper being used typically.

### <Fixing Step and Fixing Unit>

The fixing step is a step of fixing, using a fixing unit, the toner image that has been transferred onto the recording medium. When two or more color toners are used, the fixing step may be performed every after a toner image of each color is transferred onto the recording medium; or the fixing step may be performed at one time after toner images of all colors are superposed on top of one another on the recording medium. The fixing unit is not particularly limited and may employ a thermal fixing method using a known heating-pressing device. Examples of the heating-pressing device include: a combination of a heating roller and a pressing roller; and a combination of a heating roller, a pressing roller and an endless belt. The heating temperature is generally 80° C. to 200° C. Optionally, a known photo-fixing device or a similar device may be used together with the fixing unit.

Conventionally, when such a thermal fixing method is employed for a fixing unit, half or more of the total power consumed by the image forming apparatus is used for heating the toner with the fixing unit employing the thermal fixing method. Meanwhile, from the viewpoint of countermeasures to environmental problems in recent years, demand has arisen for an image forming apparatus consuming lower power (energy saving).

For example, the DSM (demand-side Management) program of International Energy Agency (IEA) in the 1999 fiscal year includes a technology procurement project of the next-generation copiers and describes their requirement specification, where copiers with 30 cpm or higher have been required for remarkable energy saving as compared with the conventional copiers. Specifically, these copiers have to have a waiting time of 10 sec or shorter during which the consumption power is set to 10 Watt to 30 Watt (which is varied with the copying speed). Therefore, energy saving must be achieved in the fixing unit which consumes high consumption power.

One essential technical matter to achieve in order to meet the above requirement and shorten the waiting time is to reduce the temperature at which the toner starts to melt, thereby reducing the fixing temperature during use. In order to respond to the reduction in the fixing temperature, the image forming apparatus of the present invention uses the toner of the present invention.

The fixing unit has been being improved for energy saving. Among the thermal fixing methods, the thermal roller fixing method, where a heating roller is pressed directly against the toner image on the recording medium for fixing, has widely been employed because of good thermal efficiency. In another employable method, a heating roller is made to have low thermal capacity, thereby improving the response of the toner to the temperature. However, the lowered specific thermal capacity of the heating roller results in a greater difference in temperature between portions through which the recording medium has passed and portions through which the recording medium has not passed, causing adhesion of the toner to the fixing roller. As a result, after the fixing roller has been rotated once, so-called hot offset phenomenon occurs where the toner is fixed on the non-image portions of the recording medium. Thus, there are stricter requirements on the toner for low-temperature fixing property and hot offset resistance. Therefore, the image forming apparatus of the present invention uses the toner of the present invention which is excellent in both low-temperature fixing property and hot offset resistance.

### <Other Steps and Other Units>

### —Charge-Eliminating Step and Charge-Eliminating Unit—

The charge-eliminating step is a step of applying a charge-eliminating bias to the latent electrostatic image bearing member to eliminate charges thereof, and can be preferably performed by a charge-eliminating unit.

The charge-eliminating unit is not particularly limited and may be appropriately selected from known charge-eliminating devices, so long as it can apply a charge-eliminating bias to the latent electrostatic image bearing member. For example, the charge-eliminating device is preferably a charge-eliminating lamp.

### —Cleaning Step and Cleaning Unit—

The cleaning step is a step of removing the toner remaining on the latent electrostatic image bearing member, and can be preferably performed by a cleaning unit.

The cleaning unit is not particularly limited and may be appropriately selected from known cleaners, so long as it can remove the toner remaining on the latent electrostatic image bearing member. Examples of the cleaners include a magnetic blush cleaner, an electrostatic brush cleaner, a magnetic roller cleaner, a blade cleaner, a brush cleaner and a web cleaner.

### —Recycling Step and Recycling Unit—

The recycling step is a step of recycling the toner removed in the cleaning step to the developing unit, and can be preferably performed by a recycling unit.

The recycling unit is not particularly limited and may be, for example, a known conveying unit.

### —Controlling Step and Controlling Unit—

The controlling step is a step of controlling each of the above steps, and can be preferably performed by a controlling unit.

The controlling unit is not particularly limited and may be appropriately selected depending on the purpose, so long as it can control the operation of each of the above units. Examples thereof include devices such as a sequencer and a computer.

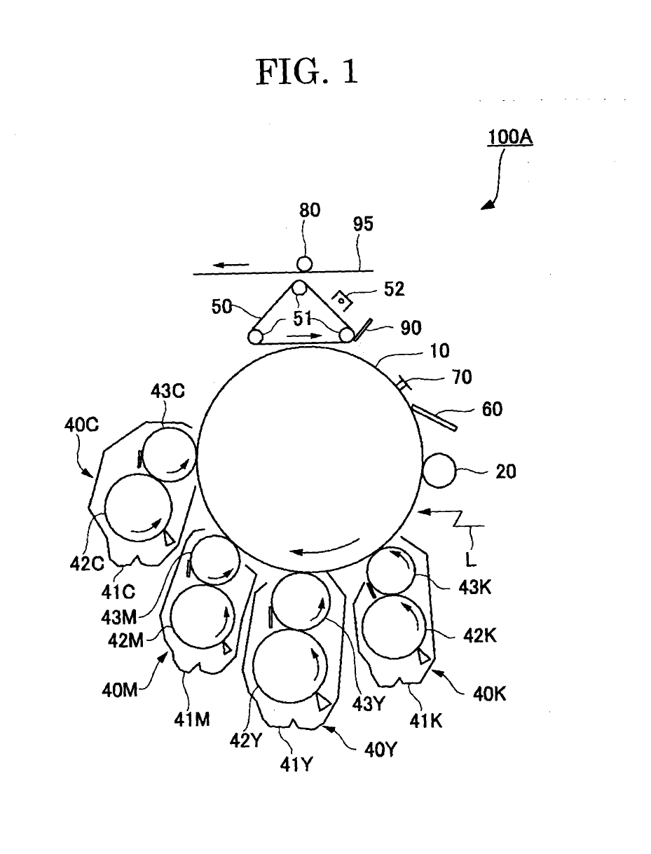

FIG. 1 illustrates an exemplary image forming apparatus of the present invention. An image forming apparatus 100A in FIG. 1 includes: a photoconductor drum 10 serving as the latent electrostatic image bearing member; a charging roller 20 serving as the charging unit; an exposing device serving as the exposing unit; developing devices each serving as the developing unit (i.e., a black toner-developing device 40K, a yellow-toner developing device 40Y, a magenta-toner developing device 40M, and a cyan-toner developing device 40C); an intermediate transfer member 50; a cleaning device 60 having a cleaning blade and serving as the cleaning unit; a charge-eliminating lamp 70 serving as the charge-eliminating unit; and a fixing device serving as the fixing unit.

The intermediate transfer member 50 is an endless belt and can be moved in a direction indicated by the arrow with being stretched by three support rollers 51 which are provided in a loop of the belt. Some of the three support rollers 51 serve also as a transfer bias roller capable of applying a predetermined transfer bias (primary transfer bias) to the intermediate transfer member 50. A cleaning device 90 having a cleaning blade is disposed in the vicinity of the intermediate transfer member 50. Also, a transfer roller 80 is disposed so as to face the intermediate transfer member 50 and serves as a transfer unit capable of applying a transfer bias for transferring (secondarily transferring) a toner image onto recording paper 95. Around the intermediate transfer member 50, a corona charging device 52 for applying charges to the toner image on the intermediate transfer member 50 is disposed between a contact point of the intermediate transfer member 50 with the photoconductor drum 10 and a contact portion of the intermediate transfer member 50 with the recording paper 95.

The developing devices for black (K), yellow (Y), magenta (M) and cyan (C) toners (i.e., the black toner-developing device 40K, the yellow toner-developing device 40Y, the magenta toner-developing device 40M, and the cyan toner-developing device 40C) each contain a developer-accommodating section (41K, 41Y, 41M or 41C), a developer supplying roller (42K, 42Y, 42M or 42C) and a developer roller (43K, 43Y, 43M or 43C).

In the image forming apparatus 100A, the charging roller 20 uniformly charges the photoconductor drum 10. The photoconductor drum 10 is imagewise exposed to light L emitted from an exposing device to form a latent electrostatic image. The latent electrostatic image formed on the photoconductor drum 10 is developed with a developer supplied from each of the developing devices 40, to thereby form a toner image. The toner image is transferred onto the intermediate transfer member 50 (primary transfer) with a transfer bias applied from the rollers 51. The image transferred onto the intermediate transfer member 50 is charged with a corona charging device 52 and then is transferred onto the recording paper 95 (secondary transfer). The toner image transferred onto the recording paper 95 is heated and pressed by a heating roller and a pressing roller of the fixing unit, so that the toner image is melted and fixed on the recording paper 95. Notably, the toner particles remaining on the photoconductor drum 10 are removed by the cleaning unit 60, and the charges on the photoconductor drum 10 are eliminated by the charge-eliminating lamp 70.

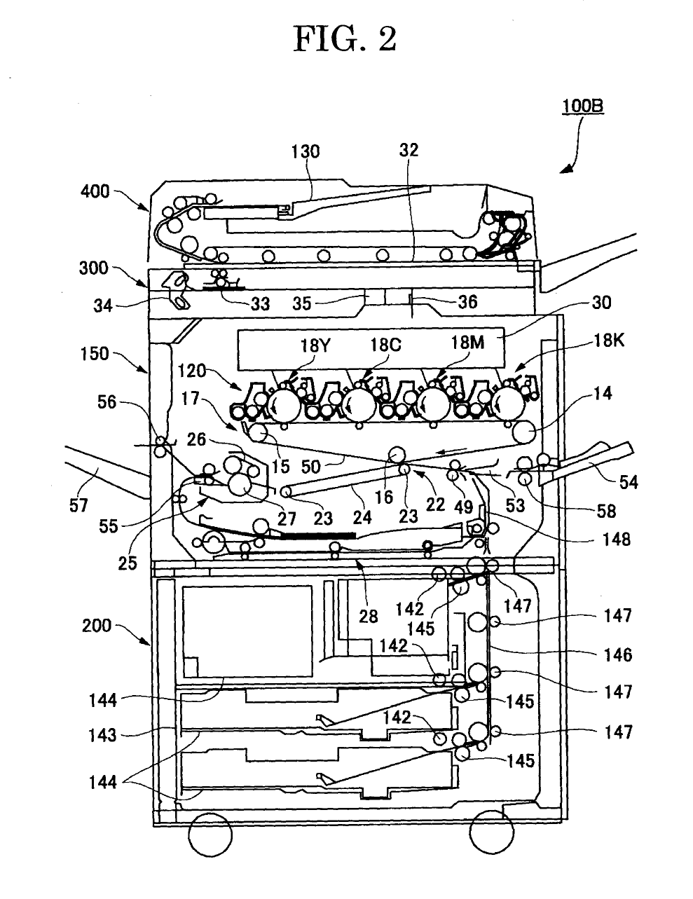

FIG. 2 illustrates another exemplary image forming apparatus of the present invention. An image forming apparatus 100B in FIG. 2 is a tandem color image forming apparatus, and includes a copying device main body 150, a paper-feeding table 200, a scanner 300 and an automatic document feeder (ADF) 400.

The copying device main body 150 is provided at its center portion with an endless belt-form intermediate transfer member 50. The intermediate transfer member 50 can be rotated with being stretched by support rollers 14, 15 and 16 in a direction indicated by the arrow. A cleaning unit 17 configured to remove the toner particles remaining on the intermediate transfer member 50 is disposed in the vicinity of the support roller 15. Around the intermediate transfer member 50 stretched by the support rollers 14 and 15 is provided a tandem developing device 120 in which four image forming units 18K, 18Y, 18M and 18C for yellow (Y), cyan (C), magenta (M) and black (K) toners are arranged in a row along the moving direction of the intermediate transfer member.

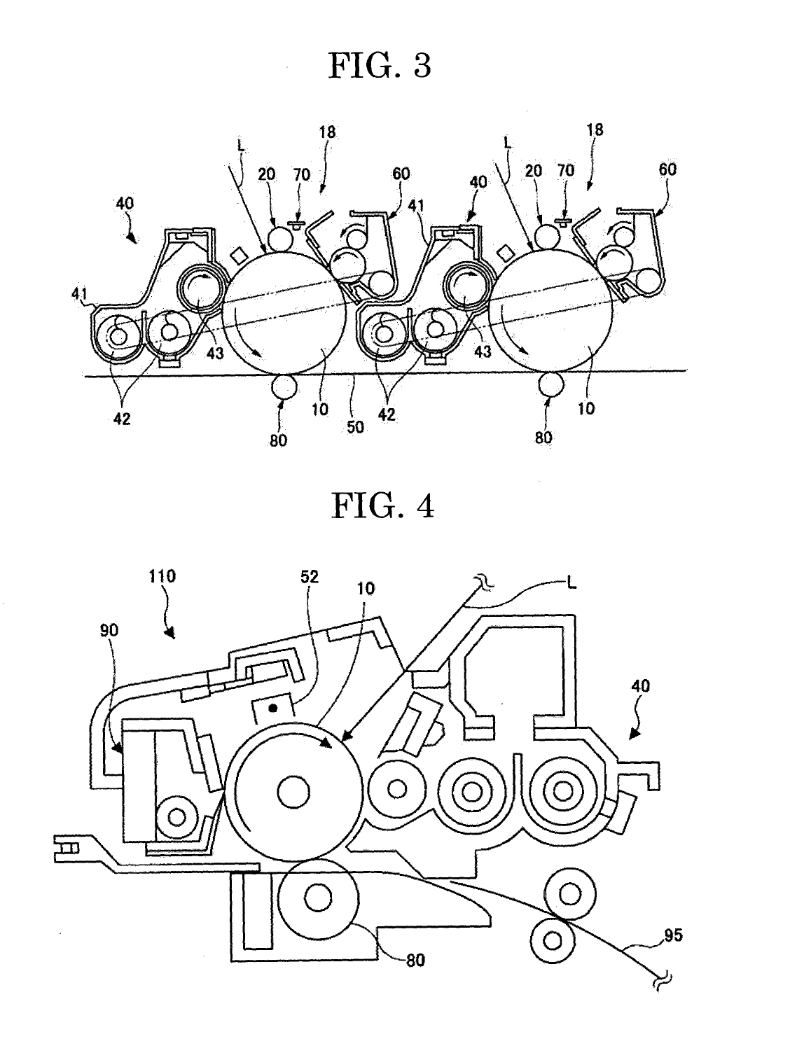

As illustrated in FIG. 3, each of the image forming units 18 includes: a photoconductor drum 10; a charging roller 20 which uniformly charges the photoconductor drum 10; a developing device 40 which forms a toner image by developing a latent electrostatic image formed on the photoconductor drum 10 with a developer of black (K), yellow (Y), magenta (M) or cyan (C); a transfer roller 80 which transfers the toner image onto an intermediate transfer member 50; a cleaning unit 60; and a charge-eliminating lamp 70.

In addition, an exposing unit 30 is provided in the vicinity of the tandem developing device 120. The exposing unit 30 applies light L to the photoconductor drum 10 to form a latent electrostatic image.

Also, a secondary transfer unit 22 is provided on the intermediate transfer member 50 on the side opposite to the side where the tandem developing device 120 is disposed. The secondary transfer device 22 includes an endless belt-form secondary transfer belt 24 and a pair of support rollers 23 stretching the secondary transfer belt 24. The recording paper conveyed on the secondary transfer belt 24 can come into contact with the intermediate transfer member 50.

A fixing unit 25 is provided in the vicinity of the secondary transfer unit 22. The fixing unit 25 includes an endless-form fixing belt 26 and a pressing roller 27 disposed so as to be pressed against the fixing belt 26. One of the rollers stretching the fixing belt 26 is a heating roller. Also, when image formation is performed on both sides of recording paper, a sheet-reversing device 28 for reversing the recording paper is disposed in the vicinity of the secondary transfer device 22 and the fixing device 25.

Next will be described formation of a full color image (color copy) using an image forming apparatus 100B having the above-described configuration. First, an original document is set on a document table 130 of the automatic document feeder (ADF) 400. Alternatively, the automatic document feeder 400 is opened and then an original document is set on a contact glass 32 of the scanner 300, followed by closing of the automatic document feeder 400. In the former case, when a starting switch is pressed, the scanner 300 is operated to run a first carriage 33 and a second carriage 34 after the original document has been transferred onto the contact glass 32. In the latter case, when a starting switch is pressed, the scanner 300 is immediately operated to run a first carriage 33 and a second carriage 34. At that time, the first carriage 33 irradiates the original document with light from a light source, and then the second carriage 34 reflects, on its mirror, light reflected by the original document. The thus-reflected light is received by a reading sensor 36 through an imaging lens 35 for reading the original document (color image), to thereby generate image information corresponding to black, yellow, magenta and cyan.

Furthermore, based on the thus-obtained image information, a latent electrostatic image corresponding to each color is formed on the photoconductor drum 10 with the exposing device 30. Subsequently, the latent electrostatic image is developed with a developer supplied from the developing device 40 for each color toner, to thereby form color toner images. The thus-formed color toner images are sequentially superposed (primarily transferred) on top of one another on the intermediate transfer member 50 which is being rotated by the support rollers 14, 15 and 16, whereby a composite toner image is formed on the intermediate transfer member 50.

In the paper-feeding table 200, one of paper-feeding rollers 142 is selectively rotated to feed recording paper sheets from one of vertically stacked paper-feeding cassettes 144 housed in a paper bank 143. The thus-fed sheets are separated from one another by a separating roller 145. The thus-separated sheet is fed through a paper-feeding path 146, then fed through a paper-feeding path 148 in the copying device main body 150 by a transfer roller 147, and stopped at a registration roller 49. Alternatively, recording paper sheets placed on a manual-feeding tray 54 are fed, and the thus-fed sheets are separated from one another by a separating roller 58. The thus-separated sheet is fed through a manual paper-feeding path 53, and stopped at a registration roller 49. Notably, the registration roller 49 is generally connected to the ground in use. Alternatively, it may be used while a bias is being applied thereto for removing paper dust from the recording paper sheets.

The registration roller 49 is rotated to feed a recording paper sheet between the intermediate transfer member 50 and the secondary transfer unit 22 so that the composite toner image formed on the intermediate transfer member 50 can be transferred (secondarily transferred) onto the recording paper sheet.

The recording paper sheet having the composite toner image is fed by the secondary transfer unit 22 to the fixing unit 25. In the fixing unit 25, the fixing belt 26 and the pressing roller 27 fixes the composite toner image on the recording paper sheet through application of heat and pressure. Subsequently, the recording paper sheet is discharged from a discharge roller 56 by a switching claw 55 and then stacked on a discharge tray 57. Alternatively, the recording paper sheet is reversed with the sheet-reversing unit 28 by a switching claw 55 and conveyed again to a position where transfer is performed. Thereafter, an image is also formed on the back surface thereof, and then the thus-obtained sheet is discharged from a discharge roller 56 and stacked on a discharge tray 57.

Notably, a cleaning unit 17 removes the toner particles remaining on the intermediate transfer member 50 after the transfer of the composite toner image.

### <Process Cartridge>

A process cartridge used in the present invention includes at least a latent electrostatic image bearing member configured to bear a latent electrostatic image and a developing unit configured to develop the latent electrostatic image formed on the latent electrostatic image bearing member with the toner of the present invention, to thereby form a visible image; and, if necessary, further includes appropriately selected other units such as a charging unit, a developing unit, a transfer unit, a cleaning unit and a charge-eliminating unit. The process cartridge of the present invention is detachably mounted to the main body of the image forming apparatus.

The developing unit includes at least a developer-accommodating container which accommodates the toner or developer of the present invention, and a developer bearing member configured to bear and transfer the toner or developer accommodated in the developer container. The developing unit may further include other members such as a member for regulating the thickness of the toner to be borne. The process cartridge of the present invention can be detachably mounted to various electrophotographic image forming apparatus, facsimiles and printers. Preferably, the process cartridge of the present invention is detachably mounted to the image forming apparatus of the present invention.

As illustrated in FIG. 4, a process cartridge 110 includes a latent electrostatic image bearing member 10, a charging unit 52, a developing unit 40, a transfer unit 80 and a cleaning unit 90; and, if necessary, further includes other units. In FIG. 4, reference characters 95 and L denote respectively a recording paper sheet and light emitted from an exposing unit.

The developing unit includes at least a developer-accommodating container which accommodates the developer of the present invention, and a developer bearing member configured to bear and transfer the developer accommodated in the developer-accommodating container. Notably, the developing unit may further include other members such as a member for regulating the thickness of the developer to be borne.

Next, description will be given to image forming process by the process cartridge illustrated in FIG. 4. While being rotated in a direction indicated by the arrow, the latent electrostatic image bearing member 10 is charged with the charging unit 52 and then is exposed to light L emitted from the exposing unit. As a result, a latent electrostatic image in response to the exposure pattern is formed on the surface of the latent image bearing member. The latent electrostatic image is developed with the toner in the developing unit 40. The developed toner image is transferred with the transfer unit 80 onto the recording paper sheet 95, which is then printed out. Next, the surface of the latent electrostatic image bearing member from which the toner image has been transferred is cleaned with the cleaning unit 90, and is charge-eliminated with the charge-eliminating unit. The above-described process is repeatedly performed.

The image forming method, the image forming apparatus and the process cartridge of the present invention can efficiently form high-quality images for a long period of time, since they use the toner of the present invention which exhibits good fixing property at 150° C. or lower to form good fixed images and which, even when used in high-speed copiers, can highly suppress the contamination inside the copiers due to volatile wax dust particles and the release of the dust particles to the outside.

### Examples

The present invention will next be described by way of Examples, which should not be construed as limiting the present invention thereto.

### (Synthesis Example of Ester Wax)

The fatty acid components shown in Table 1 and the alcohol components shown in Table 1 in the molar ratios shown in Table 1 were added to a reaction container together with an effective amount of sulfuric acid serving as a catalyst. Under nitrogen flow, these fatty acid components and these alcohol components were esterified at 240° C. to synthesize monoester waxes 1 to 11 and polyester wax shown in Table 1.

Next, the obtained ester waxes were measured for various properties as follows. The results are shown in Table 1.

### <Measurement of Endothermic Peak Temperature of Wax at the Second Temperature Rising>

The endothermic peak temperature (melting point) of each ester wax at the second temperature rising was measured in the following manner using a DSC system (differential scanning calorimeter) (“Q-200,” product of TA INSTRUMENTS Co.).

Specifically, first, about 5.0 mg of the wax to be measured was precisely weighed and placed in a sample container made of aluminum; the sample container was placed on a holder unit; and the holder unit was set in an electric furnace. Next, in a nitrogen atmosphere (flow rate: 50 mL/min), the sample was heated from −20° C. to 150° C. under the following conditions: temperature increasing rate: 1° C./min; temperature modulation cycle: 60 sec; and temperature modulation amplitude: 0.159° C.; and then the sample was cooled from 150° C. to 0° C. at a temperature decreasing rate of 10° C./min. Thereafter, the sample was heated again to 150° C. at a temperature increasing rate of 1° C./min. The DSC curve obtained using the differential scanning calorimeter (“Q-200,” product of TA INSTRUMENTS Co.) was used to determine the endothermic peak temperature attributed to the ester wax at the second temperature rising.

### <Measurement of Complex Viscosities η*a and η*b of Wax>

The dynamic viscoelasticity of the ester wax was measured with the ARES measuring apparatus (product of Rheometric Scientific Co.).

First, a wax sample was molded into a tablet. Then, parallel plates 50 mm in diameter were set to the top of the geometry and a cup 50 mm in diameter was set at the bottom thereof. After 0 point adjustment had been performed so that the normal force became 0, sine wave vibration was applied to the tablet at a vibration frequency of 6.28 rad/s to 62.8 rad/s. The interval between the parallel plates was set to 1.0 mm, and measurement was preformed within −15° C. to +15° C. of the melting point of the wax.

η*a denotes a complex viscosity (Pa·s) determined by measuring a dynamic viscoelasticity of the wax at a measurement frequency of 6.28 rad/s, and η*b denotes a complex viscosity (Pa·s) determined by measuring a dynamic viscoelasticity of the wax at a measurement frequency of 62.8 rad/s.

TABLE 1-1

| | | | | | | Polyhydric |
|---|---|---|---|---|---|---|
| | Long-chain fatty acid | | | Higher alcohol | | alcohol |
| | Palmitic | Stearic | Behenic | Steary | Behenyl | Penta- |
| | acid | acid | acid | alcohol | alcohol | erythritol |
| Monoester wax 1 | — | 80 | 20 | 100 | — | — |
| Monoester wax 2 | — | 70 | 30 | 100 | — | — |
| Monoester wax 3 | 10 | 70 | 20 | 80 | 20 | — |
| Monoester wax 4 | — | 80 | 20 | 100 | — | — |
| Monoester wax 5 | 30 | 70 | — | 80 | 20 | — |
| Monoester wax 6 | — | 100 | — | 100 | — | — |
| Monoester wax 7 | 70 | 20 | 10 | 70 | 30 | — |
| Polyester wax | — | 80 | 20 | — | — | 100 |
| Monoester wax 8 | 40 | 40 | 20 | 100 | — | — |
| Monoester wax 9 | 40 | 60 | — | 70 | 30 | — |
| Monoester wax 10 | — | — | 100 | — | 100 | — |
| Monoester wax 11 | 40 | 30 | 30 | 80 | 20 | — |

| | |
|---|---|
| Paraffin wax | Product of NIPPON SEIRO CO., LTD. |
| Microcrystalline wax | Product of NIPPON SEIRO CO., LTD. |
| Polyalkylene wax | Product of NIPPON SEIRO CO., LTD. |

TABLE 1-2

| | | Ratio | Endothermic peak |
|---|---|---|---|
| | Complex | of complex | temperature at the |
| | viscosity | viscosities | second temperature |
| | η*a (Pa · s) | (η*b/η*a) | rising (° C.) |
| Monoester wax 1 | 1.5 | 0.03 | 70.3 |
| Monoester wax 2 | 2.0 | 0.02 | 78.1 |
| Monoester wax 3 | 1.1 | 0.02 | 68.4 |
| Monoester wax 4 | 1.6 | 0.98 | 79.0 |
| Monoester wax 5 | 1.5 | 0.02 | 64.3 |
| Monoester wax 6 | 1.6 | 0.05 | 79.9 |
| Monoester wax 7 | 1.2 | 0.03 | 62.1 |
| Polyester wax | 1.7 | 0.29 | 67.6 |
| Monoester wax 8 | 2.5 | 1.06 | 79.5 |
| Monoester wax 9 | 1.8 | 0.0009 | 64.9 |
| Monoester wax 10 | 1.8 | 0.34 | 91.2 |
| Monoester wax 11 | 1.2 | 0.06 | 54.0 |
| Paraffin wax | 0.9 | 0.89 | 74.8 |
| Microcrystalline wax | 1.0 | 0.90 | 84.2 |
| Polyalkylene wax | 0.3 | 1.13 | 80.1 |

### Example 1

### Production of Toner

### —Preparation of Fine Organic Particle Emulsion—

A reaction container equipped with a stirring rod and a thermometer was charged with water (683 parts by mass), a sodium salt of sulfuric acid ester of methacrylic acid-ethylene oxide adduct (ELEMINOL RS-30: product of Sanyo Chemical Industries, Ltd.) (11 parts by mass), styrene (83 parts by mass), methacrylic acid (83 parts by mass), butyl acrylate (110 parts by mass) and ammonium persulfate (1 part by mass), and the resultant mixture was stirred at 400 rpm for 15 min to prepare a white emulsion. The thus-obtained emulsion was heated to 75° C. and allowed to react for 5 hours. Subsequently, a 1% by mass aqueous ammonium persulfate solution (30 parts by mass) was added to the reaction mixture, followed by aging at 75° C. for 5 hours, to thereby prepare an aqueous dispersion liquid [fine particle dispersion liquid] of a vinyl resin (a copolymer of styrene/methacrylic acid/butyl acrylate/sodium salt of sulfuric acid ester of methacrylic acid ethylene oxide adduct).

The thus-prepared [fine particle dispersion liquid] was measured for volume average particle diameter with a particle size analyzer (LA-920, product of Horiba, Ltd.) and was found to have a volume average particle diameter of 0.10 μm.

Part of the [fine particle dispersion liquid] was dried to separate resin. The thus-separated resin was found to have a glass transition temperature (Tg) of 57° C. and a weight average molecular weight of 121,000.

### —Preparation of Aqueous Phase—

Water (990 parts by mass), [fine particle dispersion liquid] (80 parts by mass), a 48.5% by mass aqueous solution of sodium dodecyldiphenyl ether disulfonate (ELEMINOL MON-7, product of Sanyo Chemical Industries Ltd.) (40 parts by mass) and ethyl acetate (90 parts by mass) were mixed together and stirred to obtain an opaque white liquid, which was used as [aqueous phase 1].

### —Synthesis of Low-Molecular-Weight Polyester Resin—

A reaction container equipped with a condenser, a stirrer and a nitrogen-introducing pipe was charged with bisphenol A propylene oxide 3 mol adduct (781 parts by mass), terephthalic acid (218 parts by mass), adipic acid (48 parts by mass) and dibutyl tinoxide (2 parts by mass), followed by reaction at 230° C. for 13 hours under normal pressure. Next, the reaction mixture was allowed to react for 7 hours at a reduced pressure of 10 mmHg to 15 mmHg. Then, trimellitic anhydride (45 parts by mass) was added to the reaction container, followed by reaction at 180° C. for 2 hours under normal pressure, to thereby obtain [low-molecular-weight polyester resin].

The obtained [low-molecular-weight polyester resin] was found to have a number average molecular weight of 9,600, a weight average molecular weight of 28,000, a glass transition temperature (Tg) of 43° C. and an acid value of 12.2 mgKOH/g.

### —Synthesis of Crystalline Polyester Resin—

A 5 L four-neck flask equipped with a nitrogen-introducing pipe, a drainpipe, a stirrer and a thermocouple was charged with 1,12-dodecanediol (2,500 g), 1,8-octanedioic acid (2,330 g) and hydroquinone (4.9 g), followed by reaction at 180° C. for 20 hours. Thereafter, the reaction mixture was allowed to react at 200° C. for 6 hours and further react at 8.3 kPa for 10 hours, to thereby produce [crystalline polyester resin 1].

The obtained [crystalline polyester resin 1] was found to have a melting point of 69° C., a SP of 9.9, and a weight average molecular weight of 15,000 as measured through GPC.

Notably, the melting point of the crystalline polyester resin was measured as the maximum endothermic peak using differential scanning calorimeter TG-DSC SYSTEM TAS-100 (product of Rigaku Corporation).

### —Synthesis of Prepolymer—

A reaction container equipped with a condenser, a stirrer and a nitrogen-introducing pipe was charged with bisphenol A ethylene oxide 2 mol adduct (682 parts by mass), bisphenol A propylene oxide 2 mol adduct (81 parts by mass), terephthalic acid (283 parts by mass), trimellitic anhydride (22 parts by mass) and dibutyl tinoxide (2 parts by mass), followed by reaction at 230° C. for 8 hours under normal pressure. Next, the reaction mixture was allowed to react for 5 hours at a reduced pressure of 10 mmHg to 15 mmHg, to thereby obtain [intermediate polyester]. The obtained [intermediate polyester] was found to have a number average molecular weight of 2,100, a weight average molecular weight of 9,500, a glass transition temperature (Tg) of 55° C., an acid value of 0.5 mgKOH/g and a hydroxyl value of 49 mgKOH/g.

Next, a reaction container equipped with a condenser, a stirrer and a nitrogen-introducing pipe was charged with the [intermediate polyester] (411 parts by mass), isophorone diisocyanate (89 parts by mass) and ethyl acetate (500 parts by mass), followed by reaction at 100° C. for 5 hours, to thereby obtain [prepolymer].

### —Preparation of Masterbatch—

Carbon black (REGAL 400R, product of Cabot Corporation) (40 parts by mass), a polyester resin (60 parts by mass) (RS-801, product of Sanyo Chemical Industries, Ltd., acid value: 10 mgKOH/g, weight average molecular weight (Mw): 20,000, glass transition temperature (Tg): 64° C.) and water (30 parts by mass) were mixed together using HENSCHEL MIXER, to thereby obtain a mixture containing pigment aggregates impregnated with water.

The obtained mixture was kneaded for 45 min with a two-roll mill whose roll surface temperature had been adjusted to 130° C. The kneaded product was pulverized with a pulverizer so as to have a diameter of 1 mm, whereby [masterbatch] was obtained.

### —Synthesis of Ketimine Compound—

A reaction container equipped with a stirring rod and a thermometer was charged with isophorone diamine (170 parts by mass) and methyl ethyl ketone (75 parts by mass), followed by reaction at 50° C. for 5 hours, to thereby produce [ketimine compound]. The amine value of the obtained [ketimine compound] was found to be 418.

### —Preparation of Oil Phase—

A container to which a stirring rod and a thermometer had been set was charged with the above-obtained [low-molecular-weight polyester resin] (378 parts by mass), the above-obtained [crystalline polyester resin 1] (220 parts by mass), the above-obtained [monoester wax 1] (110 parts by mass) and ethyl acetate (947 parts by mass), and the mixture was heated to 80° C. under stirring. The resultant mixture was maintained at 80° C. for 5 hours and then cooled to 30° C. for 1 hour, to thereby obtain [raw material solution].

The obtained [raw material solution] (1,324 parts by mass) was placed in a container and treated with a bead mill (“ULTRA VISCOMILL,” product of AIMEX CO., Ltd.) under the following conditions: a liquid feed rate of 1 kg/hr, disc circumferential velocity of 6 m/s, 0.5 mm-zirconia beads packed to 80% by volume, and 3 passes.

Subsequently, the above-prepared [masterbatch] (500 parts by mass) and the above-synthesized [prepolymer] (109.4 parts by mass) were added to the [raw material solution], and the resultant mixture was passed once with the bead mill under the above conditions, to thereby obtain [oil phase dispersion liquid].

The solid content concentration of the obtained [oil phase dispersion liquid] was found to be 50% by mass (130° C., 30 minutes).

### —Emulsification, Deformation and Desolvation—

The above-prepared [oil phase dispersion liquid] (800 parts by mass) and the above-synthesized [ketimine compound] (6.6 parts by mass) were added to a container, followed by mixing for 1 minute at 5,000 rpm with a TK homomixer (product of Tokushu Kika Kogyo Co., Ltd.). Thereafter, the above-prepared [aqueous phase] (1,200 parts by mass) was added to the container, and the resultant mixture was mixed with the TK homomixer at 13,000 rpm for 3 minutes, to thereby obtain [emulsified slurry].

The obtained [emulsified slurry] was added to a container to which a stirrer and a thermometer had been set and was left to stand still at 15° C. for 1 hour, followed by desolvation at 30° C. for 1 hour, to thereby produce [dispersion slurry].

The obtained [dispersion slurry] was found to have a volume average particle diameter of 5.95 μm and a number average particle diameter of 5.45 μm, which were measured with MULTISIZER II.

### —Washing and Drying—

The obtained [dispersion slurry] (100 parts by mass) was filtrated under reduced pressure. Ion-exchange water (100 parts by mass) was added to the filtration cake, followed by mixing with a TK homomixer (at 12,000 rpm for 10 min) and filtrating. Next, 10% by mass aqueous sodium hydroxide solution (100 parts by mass) was added to the filtration cake, and the resultant mixture was mixed with a TK homomixer (at 12,000 rpm for 30 min) under application of ultrasonic vibration, followed by filtrating under reduced pressure.

This washing with sodium hydroxide under application of ultrasonic vibration was performed again, twice in total.

Next, 10% by mass aqueous hydrochloric acid solution (100 parts by mass) was added to the filtration cake, and the resultant mixture was mixed with a TK homomixer (at 12,000 rpm for 10 min), followed by filtrating. Next, ion-exchange water (300 parts by mass) was added to the filtration cake, and the resultant mixture was mixed with a TK homomixer (at 12,000 rpm for 10 min), followed by filtrating. This treatment of adding the ion-exchange water, mixing and filtrating was performed twice to thereby [filtration cake 1].

The obtained [filtration cake 1] was dried with an air-circulation dryer at 45° C. for 48 hours, and then sieved with a mesh having an opening size of 75 μm to obtain toner base particles.

Hydrophobic silica (0.7 parts by mass) and hydrophobic titanium oxide (0.3 parts by mass) were mixed with the obtained toner base particles (100 parts by mass) using HENSCHEL MIXER, to thereby produce toner 1.

### Example 2

### Production of Toner

The procedure of Example 1 was repeated, except that the [monoester wax 1] was changed to the [monoester wax 2], to thereby produce toner 2.

### Example 3

### Production of Toner

The procedure of Example 1 was repeated, except that the [monoester wax 1] was changed to the [monoester wax 3], to thereby produce toner 3.

### Example 4

### Production of Toner

The procedure of Example 1 was repeated, except that the [monoester wax 1] was changed to the [monoester wax 4], to thereby produce toner 4.

### Example 5

### Production of Toner

The procedure of Example 1 was repeated, except that the [monoester wax 1] was changed to the [monoester wax 5], to thereby produce toner 5.

### Example 6

### Production of Toner

The procedure of Example 1 was repeated, except that the [monoester wax 1] was changed to the [monoester wax 6], to thereby produce toner 6.

### Example 7

### Production of Toner

The procedure of Example 1 was repeated, except that the [monoester wax 1] was changed to the [monoester wax 7], to thereby produce toner 7.

### Example 8

### Production of Toner

The procedure of Example 1 was repeated, except that the [monoester wax 1] was changed to the [polyester wax], to thereby produce toner 8.

### Comparative Example 1

### Production of Toner

The procedure of Example 1 was repeated, except that the [monoester wax 1] was changed to the [monoester wax 8], to thereby produce toner 9.

### Comparative Example 2

The procedure of Example 1 was repeated, except that the [monoester wax 1] was changed to the [monoester wax 9], to thereby produce toner 10.

### Comparative Example 3

### Production of Toner

The procedure of Example 1 was repeated, except that the [monoester wax 1] was changed to the [monoester wax 10], to thereby produce toner 11.

### Comparative Example 4

### Production of Toner

The procedure of Example 1 was repeated, except that the [monoester wax 1] was changed to the [monoester wax 11], to thereby produce toner 12.

### Comparative Example 5

### Production of Toner

The procedure of Example 1 was repeated, except that the [monoester wax 1] was changed to the [paraffin wax (product of NIPPON SEIRO CO., LTD.)], to thereby produce toner 13.

### Comparative Example 6

### Production of Toner

The procedure of Example 1 was repeated, except that the [monoester wax 1] was changed to the [microcrystalline wax (product of NIPPON SEIRO CO., LTD.)], to thereby produce toner 14.

### Comparative Example 7

### Production of Toner

The procedure of Example 1 was repeated, except that the [monoester wax 1] was changed to the [polyalkylene wax (product of NIPPON SEIRO CO., LTD.)], to thereby produce toner 15.

### <Production of Developer>

5% by mass of each of the produced toners was mixed with 95% by mass of silicone resin-coated copper-zinc ferrite carrier particles having an average particle diameter of 40 μm using a ball mill, to thereby produce developers.

Next, each of the toners and developers was evaluated for various properties in the following manner. The results are shown in Table 2.

### <Releasing Property>

Each developer was used to print out 1,000 paper sheets of copy paper <55> (product of NBS Inc.) with an image forming apparatus (IMAGIONEO450, product of Ricoh Company, Ltd.) capable of printing 45 paper sheets of A4 size per minute. During the printing process, the number of paper jams were measured and evaluated for releasing property according to the following criteria.

### Evaluation Criteria

A: No paper jam occurred.

B: Paper jam occurred once to three times.

C: Paper jam occurred four to ten times.

D: Paper jam occurred eleven times or more.

### <Fixing Property>

The fixing portion of a copier (MF2200, product of Ricon company, Ltd.) using a TEFLON (registered trademark) roller as a fixing roller was modified so that the fixing temperature could be changed as desired. Then, copying test was performed using the thus-modified apparatus and Type 6200 paper (product of Ricoh Company, Ltd.).

Specifically, the cold offset temperature (the minimum fixing temperature) was obtained by changing the fixing temperature.

The evaluation conditions for the minimum fixing temperature were as follows: the linear velocity of paper feeding: 120 mm/sec to 150 mm/sec, the surface pressure: 1.2 kgf/cm², and the nip width: 3 mm.

The minimum fixing temperature is preferably lower since the power consumption can be lowered. The minimum fixing temperature of 130° C. or lower is a level free from problems in practical use.

### [Evaluation Criteria]

A: The minimum fixing temperature was lower than 125° C.

B: The minimum fixing temperature was 125° C. or higher but 130° C. or lower.

C: The minimum fixing temperature was 130° C. but cold offset slightly occurred.

D: The minimum fixing temperature was higher than 130° C.

### <Heat Resistance Storage Stability>

Each toner was charged into a 50 mL-glass container, which was then left to stand in a thermostat bath of 50° C. for 24 hours, followed by cooling to 24° C. The thus-treated toner was measured for penetration degree according to the penetration test (JIS K2235-1991) and evaluated for heat resistance storage stability according to the following criteria. Notably, the greater penetration degree means more excellent heat resistance storage stability. A toner having a penetration degree less than 5 mm is highly likely to cause problems in use.

### [Evaluation Criteria]

A: The penetration degree was 25 mm or greater

B: The penetration degree was 15 mm or greater but less than 25 mm.

C: The penetration degree was 5 mm or greater but less than 15 mm.

D: The penetration degree was less than 5 mm.

### <Contamination in Apparatus>

The contamination in apparatus was evaluated as follows. Specifically, a particle counter (KC01E, product of Riontech Co., Ltd.) was mounted to the gas outlet port of the main body of a copier (MF2200, product of Ricoh Company, Ltd.). Next, the copier was allowed to output paper sheets each having an image occupation rate of 20% at a fixing temperature of 180° C. for 1 min. The contamination in apparatus was evaluated based on the number of dust particles.

### [Evaluation Criteria]

A: No dust particles were detected.

B: The number of dust particles detected was less than 50,000.

C: The number of dust particles detected was 50,000 or more but less than 100,000.

D: The number of dust particles detected was 100,000 or more.

TABLE 2

| | | | | | Heat | |
|---|---|---|---|---|---|---|
| | | | | Min. | resistance | |
| | | | Releasing | fixing | storage | Contamination |
| | Toner | Releasing agent (wax) | property | temp. | stability | in apparatus |
| Ex. 1 | Toner 1 | Monoester wax 1 | A | A | A | A |
| Ex. 2 | Toner 2 | Monoester wax 2 | B | A | A | A |
| Ex. 3 | Toner 3 | Monoester wax 3 | A | B | B | A |
| Ex. 4 | Toner 4 | Monoester wax 4 | B | A | A | B |
| Ex. 5 | Toner 5 | Monoester wax 5 | A | A | B | B |
| Ex. 6 | Toner 6 | Monoester wax 6 | A | B | A | B |
| Ex. 7 | Toner 7 | Monoester wax 7 | A | A | B | A |
| Ex. 8 | Toner 8 | Polyester wax | B | B | B | A |
| Comp. Ex. 1 | Toner 9 | Monoester wax 8 | D | D | C | B |
| Comp. Ex. 2 | Toner 10 | Monoester wax 9 | C | C | D | D |
| Comp. Ex. 3 | Toner 11 | Monoester wax 10 | D | C | C | B |
| Comp. Ex. 4 | Toner 12 | Monoester wax 11 | B | D | D | A |
| Comp. Ex. 5 | Toner 13 | Paraffin wax | B | A | B | D |
| Comp. Ex. 6 | Toner 14 | Microcrystalline wax | C | D | B | B |
| Comp. Ex. 7 | Toner 15 | Polyalkylene wax | C | C | B | B |

As shown in Table 2, all the toners of Examples 1 to 8 were found to be excellent in releasing property, low-temperature fixing property, heat resistance storage stability, and contamination in apparatus and form high-quality images. In more detail, the toner of Example 2 was found to have a higher complex viscosity η*a than that of the toner of Example 1 and be less than the toner of Example 1 in amount of the releasing agent exuding from the toner. As a result, the toner or Example 2 was somewhat inferior to that of Example 1.

The toner of Example 3, compared to that of Example 1, was formed using the releasing agent having a lower complex viscosity η*a. Thus, although it exhibited comparable releasing property to that of the toner of Example 1, the amount of the releasing agent exuding from the toner was large, degrading filming and heat resistance storage stability.

Also, the amount of the releasing agent exuding from the toner of Example 4 was less than that of the toner of Example 1. As a result, the toner of Example 4 was somewhat inferior to that of Example 1.

The toner of Example 5 was formed using the releasing agent having a lower ratio (η*b/η*a) between the complex viscosities, and thus the amount of the releasing agent exuding from the toner was large and the contamination in apparatus was somewhat degraded.

The toner of Example 6 was formed using the releasing agent having a higher melting point than that of the toner of Example 1, and thus fixing property was somewhat degraded.

The toner of Example 7 was formed using the releasing agent having a lower melting point than that of the toner of Example 1. Thus, the toner of Example 7 was found to be excellent in heat resistance storage stability but be degraded in fixing property and releasing property.

The toner of Example 8 was formed using polyester wax as the releasing agent. The toner of Example 8 was found to be somewhat degraded in fixing property, releasing property and heat resistance storage stability as compared with the toner of Example 1 formed using monoester 1, but exhibit good results regarding the contamination in apparatus.

In contrast, the toners of Comparative Examples 1 to 7 were found to be degraded in any of releasing property, low fixing property, heat resistance storage stability, and contamination in apparatus. In more detail, the toner of Comparative Example 1 was formed using the releasing agent having a higher complex viscosity η*a than that of the toner of Example 1, and the amount of the releasing agent exuding from the toner was smaller, leading to degradation in releasing property. Also, in the toner of Comparative Example 2, the molecular state of the releasing agent in the toner after fixation was unstable and easier to volatilize, resulting in that the contamination in apparatus became bad. In addition, the toner of Comparative Example 2 was degraded in heat resistance storage stability. The toner of Comparative Example 3 was formed using the releasing agent having a higher melting point than that of the toner of Example 1. The toner of Comparative Example 3 was a practically usable level in terms of contamination in apparatus and storage stability, but was considerably increased in the minimum fixing temperature due to the higher-melting-point releasing agent and also was degraded in releasing property. The toner of Comparative Example 4 was formed using the releasing agent having a lower melting point than that of the toner of Example 1. Although the minimum fixing temperature of the toner of Comparative Example 4 was close to that of the toner of Example 1, the toner of Comparative Example 4 was found to be degraded in storage stability due to the lower-melting-point releasing agent. The toner of Comparative Example 5 was formed using paraffin wax and exhibited good releasing property, fixing property and heat resistance storage stability. However, the releasing agent of the toner of Comparative Example 5 was easier to exude than in the toner of Example 1 and was degraded in contamination in apparatus. The toner of Comparative Example 6 was formed using microcrystalline wax and exhibited good releasing property, contamination in apparatus and heat resistance storage stability, but was degraded in fixing property.

The toner of Comparative Example 7 was formed using polyalkylene wax as the releasing agent and exhibited good heat resistance storage stability since the polyalkylene wax has a high melting point. However, when the polyalkylene wax was used in combination with the crystalline polyester resin, it was difficult to obtain an effect of reducing the viscoelasticity, leading to degradation in minimum fixing temperature and releasing property.

Aspects of the present invention are as follows.

<1> A toner including:

a binder resin;

a releasing agent; and

a colorant,

wherein the binder resin contains a crystalline polyester resin and a non-crystalline polyester resin,

wherein the releasing agent has an endothermic peak temperature of 60° C. to 80° C. at the second temperature rising in differential scanning calorimetry, and

wherein the releasing agent is an ester wax which satisfies the following expressions (1) and (2):

1.1 Pa·s≦η*a≦2.0 Pa·s Expression (1)

0.001≦η*b/η*a≦1.00 Expression (2)

where in Expressions (1) and (2), η*a denotes a complex viscosity (Pa·s) determined by measuring a dynamic viscoelasticity of the releasing agent at a measurement frequency of 6.28 rad/s, and η*b denotes a complex viscosity (Pa·s) determined by measuring a dynamic viscoelasticity of the releasing agent at a measurement frequency of 62.8 rad/s.

<2> The toner according to <1>, wherein the ester wax satisfies the following expressions (1′) and (2′):

1.2 Pa·s≦η*a≦1.8 Pa·s Expression (1′)

0.010≦η*b/η*a≦0.80 Expression (2′)

<3> The toner according to <1> or <2>, wherein the endothermic peak temperature at the second temperature rising in the differential scanning calorimetry is 70° C. to 80° C.

<4> The toner according to any one of <1> to <3>, wherein the releasing agent is a monoester wax.

<5> The toner according to any one of <1> to <4>, wherein an amount of the ester wax contained in the toner is 3 parts by mass to 40 parts by mass per 100 parts by mass of the binder resin.

<6> The toner according to any one of <1> to <5>, wherein the toner is obtained by dispersing in an aqueous medium an oil phase which is obtained by dissolving or dispersing in an organic solvent an active hydrogen group-containing compound, a binder resin precursor containing a site reactive with the active hydrogen group-containing compound, the crystalline polyester resin, the colorant and the ester wax, to thereby prepare an emulsified dispersion liquid, where the binder resin precursor and the active hydrogen group-containing compound are allowed to react, followed by removing the organic solvent.

<7> The toner according to any one of <1> to <6>, wherein the crystalline polyester resin has a melting point of 55° C. to 80° C.

<8> A developer including:

the toner according to any one of <1> to <7>.

<9> An image forming apparatus including:

a latent electrostatic image bearing member;

a charging unit configured to charge a surface of the latent electrostatic image bearing member;

an exposing unit configured to expose the charged surface of the latent electrostatic image bearing member to light, to thereby form a latent electrostatic image;

a developing unit configured to develop the latent electrostatic image with a toner, to thereby form a visible image;

a transfer unit configured to transfer the visible image onto a recording medium; and

a fixing unit configured to fix the transferred visible image on the recording medium,

wherein the toner is the toner according to any one of <1> to <7>.

<10> An image forming method including:

forming a latent electrostatic image on a latent electrostatic image bearing member;

developing the latent electrostatic image with a toner, to thereby form a visible image;

transferring the visible image onto a recording medium; and

fixing the transferred visible image on the recording medium,

wherein the toner is the toner according to any one of <1> to <7>.

### REFERENCE SIGNS LIST

10 Photoconductor drum
18 Image forming unit
20 Charging roller
22 Secondary transfer unit
24 Secondary transfer belt
25 Fixing unit
30 Exposing unit
40 Developing device
50 Intermediate transfer member
52 Charging unit
60 Cleaning unit
70 Charge-eliminating lamp
80 Transfer unit
90 Cleaning unit
100A Image forming apparatus
100B Image forming apparatus
110 Process cartridge
120 Tandem developing device

1. A toner comprising:
a binder resin;
a releasing agent; and
a colorant,
wherein the binder resin contains a crystalline polyester resin and a non-crystalline polyester resin,
wherein the releasing agent has an endothermic peak temperature of 60° C. to 80° C. at the second temperature rising in differential scanning calorimetry, and
wherein the releasing agent is an ester wax which satisfies the following expressions (1) and (2):
1.1 Pa·s≦η*a≦2.0 Pa·s Expression (1)
0.001≦η*b/η*a≦1.00 Expression (2)
where in Expressions (1) and (2), η*a denotes a complex viscosity (Pa·s) determined by measuring a dynamic viscoelasticity of the releasing agent at a measurement frequency of 6.28 rad/s, and η*b denotes a complex viscosity (Pa·s) determined by measuring a dynamic viscoelasticity of the releasing agent at a measurement frequency of 62.8 rad/s.

2. The toner according to claim 1, wherein the ester wax satisfies the following expressions (1′) and (2′):
1.2 Pa·s≦η*a≦1.8 Pa·s Expression (1′)
0.010≦η*b/η*a≦0.80 Expression (2′)

3. The toner according to claim 1, wherein the endothermic peak temperature at the second temperature rising in the differential scanning calorimetry is 70° C. to 80° C.

4. The toner according to claim 1, wherein the releasing agent is a monoester wax.

5. The toner according to claim 1, wherein an amount of the ester wax contained in the toner is 3 parts by mass to 40 parts by mass per 100 parts by mass of the binder resin.

6. The toner according to claim 1, wherein the toner is obtained by dispersing in an aqueous medium an oil phase which is obtained by dissolving or dispersing in an organic solvent an active hydrogen group-containing compound, a binder resin precursor containing a site reactive with the active hydrogen group-containing compound, the crystalline polyester resin, the colorant and the ester wax, to thereby prepare an emulsified dispersion liquid, where the binder resin precursor and the active hydrogen group-containing compound are allowed to react, followed by removing the organic solvent.

7. The toner according to claim 1, wherein the crystalline polyester resin has a melting point of 55° C. to 80° C.

8. A developer comprising:
a toner which comprises:
a binder resin;
a releasing agent; and
a colorant,
wherein the binder resin contains a crystalline polyester resin and a non-crystalline polyester resin,
wherein the releasing agent has an endothermic peak temperature of 60° C. to 80° C. at the second temperature rising in differential scanning calorimetry, and
wherein the releasing agent is an ester wax which satisfies the following expressions (1) and (2):
1.1 Pa·s≦η*a≦2.0 Pa·s Expression (1)
0.001≦η**b/η*a≦1.00 Expression (2)
where in Expressions (1) and (2), η*a denotes a complex viscosity (Pa·s) determined by measuring a dynamic viscoelasticity of the releasing agent at a measurement frequency of 6.28 rad/s, and η*b denotes a complex viscosity (Pa·s) determined by measuring a dynamic viscoelasticity of the releasing agent at a measurement frequency of 62.8 rad/s.

9. An image forming apparatus comprising:
a latent electrostatic image bearing member;
a charging unit configured to charge a surface of the latent electrostatic image bearing member;
an exposing unit configured to expose the charged surface of the latent electrostatic image bearing member to light, to thereby form a latent electrostatic image;
a developing unit configured to develop the latent electrostatic image with a toner, to thereby form a visible image;
a transfer unit configured to transfer the visible image onto a recording medium; and
a fixing unit configured to fix the transferred visible image on the recording medium,
wherein the toner is a toner which comprises:
a binder resin;
a releasing agent; and
a colorant,
wherein the binder resin contains a crystalline polyester resin and a non-crystalline polyester resin,
wherein the releasing agent has an endothermic peak temperature of 60° C. to 80° C. at the second temperature rising in differential scanning calorimetry, and
wherein the releasing agent is an ester wax which satisfies the following expressions (1) and (2):
1.1 Pa·s≦η*a≦2.0 Pa·s Expression (1)
0.001≦η*b/η*a≦1.00 Expression (2)
where in Expressions (1) and (2), η*a denotes a complex viscosity (Pa·s) determined by measuring a dynamic viscoelasticity of the releasing agent at a measurement frequency of 6.28 rad/s, and η*b denotes a complex viscosity (Pa·s) determined by measuring a dynamic viscoelasticity of the releasing agent at a measurement frequency of 62.8 rad/s.

10. (canceled)
